(19) United States
(12) Patent Application Publication
(10) Pub. No.: US 2024/0269876 A1
(43) Pub. Date: Aug. 15, 2024

(54) WINDOW TREATMENT CUTTING TOOL

(71) Applicant: Lutron Technology Company LLC, Coopersburg, PA (US)

(72) Inventors: David A. Kirby, Zionsville, PA (US); William Taylor Shivell, Breinigsville, PA (US)

(73) Assignee: Lutron Technology Company LLC, Coopersburg, PA (US)

(21) Appl. No.: 18/441,639

(22) Filed: Feb. 14, 2024

Related U.S. Application Data
(60) Provisional application No. 63/527,802, filed on Jul. 19, 2023.
(60) Provisional application No. 63/445,559, filed on Feb. 14, 2023.

(51) Int. Cl. B26D 3/16; B26D 7/01; B26D 7/02; E06B 9/40; E06B 9/72; G01B 3/08

(52) U.S. Cl. CPC B26D 3/166; B26D 7/02; G01B 3/08; B26D 2007/013; E06B 9/40; E06B 9/72

(57) ABSTRACT

A window treatment cutting tool may include a pair of cylindrical support tubes that are configured to support a roller tube assembly. The window treatment cutting tool may include a clamping assembly. The clamping assembly may be configured to abut the roller tube assembly to secure the roller tube assembly against the pair of cylindrical support tubes. The window treatment cutting tool may include a cutting arm assembly. The cutting arm assembly may include a blade support member and a blade attached to the blade support member. The blade support member may be configured to be biased toward the cylindrical support such that the blade contacts a flexible material of the roller tube assembly. The window treatment cutting tool may include an adapter that is configured to transfer rotation of a drill or hand crank to the one or more of the pair of cylindrical support tubes.

### CROSS-REFERENCE TO RELATED APPLICATIONS

This application claims the benefit of Provisional U.S. Patent Application No. 63/445,559, filed Feb. 14, 2023, and claims the benefit of Provisional U.S. Patent Application No. 63/527,802, filed Jul. 19, 2023, the entire disclosures of which are hereby incorporated by reference herein in their respective entireties.

### BACKGROUND

A window treatment may be mounted in front of one or more windows, for example to prevent sunlight from entering a space and/or to provide privacy. Window treatments may include, for example, roller shades, roman shades, venetian blinds, or draperies. A roller shade typically includes a flexible fabric (e.g., a shade fabric) wound onto an elongated roller tube. Such a roller shade may include a weighted hembar located at a lower end of the shade fabric. The hembar may cause the shade fabric to hang in front of one or more windows over which the roller shade is mounted.

A typical window treatment can be mounted to a structure surrounding a window, such as a window frame. Such a window treatment may include brackets at opposed ends thereof. The brackets may be configured to operably support the roller tube, such that the flexible material may be raised and lowered. For example, the brackets may be configured to support respective ends of the roller tube. The brackets may be attached to the structure, such as a wall, ceiling, window frame, or other structure.

Such a window treatment may be motorized. A motorized window treatment may include a roller tube, a motor, brackets, and a power source such as one or more batteries or electrical wiring that connects the window treatment to an external power source.

### SUMMARY

As described herein, a motorized window treatment may include a roller tube, a flexible material, a motor drive unit (e.g., a drive assembly), and mounting brackets. The roller tube may have a longitudinal axis extending in a longitudinal direction. The flexible material may be attached to the roller tube. The flexible material may be operable between a raised position and a lowered position via rotation of the roller tube. The motor drive unit may be located within the roller tube. The motor drive unit may be configured to rotate the roller tube to adjust the flexible material between the raised position and the lowered position. The motor drive unit may include an end portion that is accessible via an end of the roller tube. The motor drive unit may include a first opening on the end portion. The mounting brackets may be configured to mount the motorized window treatment to a structure.

A window treatment cutting tool may include a pair of cylindrical support tubes. The pair of cylindrical support tubes may be configured to support a roller tube assembly having a longitudinal axis. The pair of cylindrical support tubes may be parallel to one another. The window treatment cutting tool may include a clamping assembly. The clamping assembly may be configured to abut the roller tube assembly to secure the roller tube assembly against the pair of cylindrical support tubes. The window treatment cutting tool may include a cutting arm assembly. The cutting arm assembly may include an upper plate and a blade attached to the upper plate. The upper plate may be configured to be biased toward the cylindrical support such that the blade contacts a flexible material of the roller tube assembly. The window treatment cutting tool may include an adapter that is operatively coupled to one or more of the pair of cylindrical support tubes. The adapter may be configured to transfer rotation of a drill or hand crank to the one or more of the pair of cylindrical support tubes.

The clamping assembly may include a clamping tube that is positioned off-center from the top of the roller tube assembly when the clamping assembly abuts the roller tube assembly. The clamping tube may be configured to contact the roller tube assembly at a first contact location that is offset from a vertical plane defined by the roller tube assembly. The first contact location may be angularly offset from the vertical plane by between 5 and 30 degrees. A rotation axis of the clamping tube may be offset from the longitudinal axis of the roller tube assembly by a contact angle. The contact angle may be between 5 and 30 degrees. The blade may be configured to contact the roller tube assembly at a second contact location that is offset from a vertical plane defined by the roller tube assembly by an offset angle in a plane that is defined by a transverse direction that is perpendicular to the longitudinal axis of the roller tube and a radial direction R that is perpendicular to the longitudinal axis of the roller tube. The offset angle of the blade may be between 45 and 65 degrees. The blade may be oriented at an offset from a tangent defined by the roller tube assembly at the second contact location of the blade. The blade may be offset from the tangent by between 10 and 30 degrees.

The window treatment cutting tool may include a gear assembly that is operatively coupled to the adapter. The gear assembly may include a drive gear and a pair of driven gears. Each of the pair of driven gears may be operatively coupled to a respective one of the pair of cylindrical support tubes such that rotation of the drive gear is transferred to the pair of cylindrical support tubes via the pair of driven gears. The pair of cylindrical support tubes may include respective portions with teeth. The teeth of the pair of driven gears may be configured to engage with teeth of respective ones of the pair of cylindrical support tubes. The window treatment cutting tool may include a pair of guide walls located at opposed ends of the pair of cylindrical support tubes. Each of the pair of guide walls may define a notch that is configured to receive the roller tube assembly. A window treatment measuring tool may include a first portion attached to a first bracket portion, a second portion, and a third portion attached to a second bracket portion. The second portion may be configured to slidingly receive and interlock with the first portion. The third portion may be configured to slidingly receive and interlock with the second portion. The window treatment measuring tool may include a first fastener and a second fastener. The first fastener may be configured to releasably secure the first portion to the second portion. The second fastener may be configured to releasably secure the second portion to the third portion. The first portion may be configured to be slidingly adjusted with respect to the second portion and the second portion may be configured to be slidingly adjusted with respect to the third portion to adjust a length of the window treatment measuring tool. The window treatment measuring tool may be configured to transfer a window measurement to a roller tube assembly. The first fastener may be configured to prevent movement of the first portion with respect to the second portion and the second fastener may be configured to prevent movement of the second portion with respect to the third portion. The first bracket portion and the second bracket portion include holes that are configured to mark fastener locations for respective brackets for mounting the roller tube assembly. The first bracket portion and the second bracket portion are configured to represent a width of the respective brackets for mounting the roller tube assembly.

The window treatment measuring tool may include a first arm extending from the first bracket portion and a second arm extending from the second bracket portion. The first and second arms may be configured to set the depth and/or height of the window treatment measuring tool within a casing for marking fastener locations of brackets for mounting the roller tube assembly. The first arm may be configured to pivot between a retracted position and an extended position with respect to the first bracket portion. The second arm may be configured to pivot between the retracted position and the extended position with respect to the second bracket portion. The first and second arms may be configured to be substantially parallel to an outer wall of the respective first and second bracket portions when in the retracted position. The first and second arms may be configured to be substantially perpendicular to the outer wall of the respective first and second bracket portions when in the extended position.

The window treatment measuring tool may be adjustable to a plurality of lengths to match a variety of window sizes. The window treatment measuring tool may be configured to be set at a first length when placed within a window casing. The window treatment measuring tool may be configured to be adjusted to a second length such that outer faces of the first and second bracket portions abut respective sidewalls of the window casing. The second length may be greater than the first length. The window treatment measuring tool may be configured to be installed on a window treatment cutting tool to transfer a measured length to roller tube assembly. The window measurement may be the distance between inside surfaces of a window casing. The window measurement may be the distance between outer walls of a window casing.

As described herein, a motorized window treatment may be installed at a mounting location (e.g., such as a window casing). A measuring tool may be placed within the window casing. The measuring tool may comprise sliding portions and spacers at opposed ends of the measuring tool. The sliding portions may be adjusted such that outer faces of the spacers abut respective sidewalls of the window casing. The sliding portions may be secured in position with respect to one another using a fastener such that an overall length of the measuring tool corresponds to an inside width of the window casing. The inside width of the window casing may be transferred to a roller tube assembly of the motorized window treatment by placing an inside face of one of the spacers against an end of the roller tube assembly. The roller tube assembly may be cut using a blade. One or more mounting brackets may be installed within the window casing. A window treatment assembly may be assembled by installing a motor drive unit in a first end of a roller tube of the roller tube assembly and installing an idler end portion in the second end of the roller tube of the roller tube assembly. The roller tube assembly may be secured to the installed mounting brackets.

### BRIEF DESCRIPTION OF THE DRAWINGS

FIG. 1A is a perspective view of an example motorized window treatment with a roller tube in an operating position.

FIG. 1B is a perspective view of the example motorized window treatment shown in FIG. 1 with the roller tube in an extended position.

FIG. 2 is a front view of the example motorized window treatment shown in FIG. 1.

FIG. 3 is a side view of the example motorized window treatment shown in FIG. 1.

FIG. 4 is a perspective view of an example measuring tool for use with the example motorized window treatment shown in FIG. 1.

FIGS. 5A and 5B are front views of the example measuring tool shown in FIG. 4 at different length settings.

FIG. 6 is a perspective view of the example measuring tool shown in FIG. 4 inside an example window casing.

FIG. 7A is a perspective view of an example window treatment cutting tool.

FIG. 7B depicts example components of an example window treatment cutting tool kit.

FIG. 7C is a perspective view of the example window treatment cutting tool shown in FIG. 7A with a roller tube assembly received therein.

FIG. 7D is a partial cross-section view of the example window treatment cutting tool shown in FIG. 7A with a roller tube assembly received therein.

FIG. 7E is another partial cross-section view of the example window treatment cutting tool shown in FIG. 7A with a roller tube assembly received therein.

FIG. 7F is a perspective view of the example window treatment cutting tool shown in FIG. 7A with a roller tube assembly received thereon and the clamping assembly in a cutting position.

FIG. 7G is a perspective view of the example window treatment cutting tool shown in FIG. 7A with a roller tube assembly received thereon and a blade of the cutting arm assembly cutting the roller tube assembly.

FIG. 7H is another perspective view of the example window treatment cutting tool shown in FIG. 7A with the roller tube assembly having been cut.

FIG. 8A is a perspective view of another example measuring tool for use with the example motorized window treatment shown in FIG. 1.

FIGS. 8B-8D are perspective views of the example measuring tool shown in FIG. 8A at different length settings.

FIGS. 8E and 8F are partial perspective views of the example measuring tool shown in FIG. 8A with an arm in a retracted position and extended position.

FIG. 8G is a perspective view of the example measuring tool shown in FIG. 8G inside an example casing.

FIG. 8H is a perspective view of the example window treatment cutting tool shown in FIG. 7A with a roller tube assembly received thereon and the example measuring tool shown in FIG. 8A installed thereon.

FIG. 9 is a flowchart of an example installation procedure for a motorized window treatment.

### DETAILED DESCRIPTION

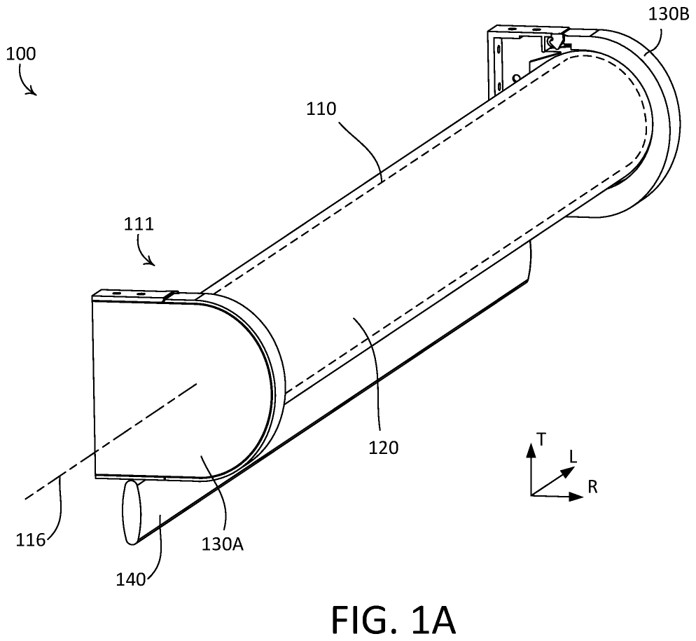

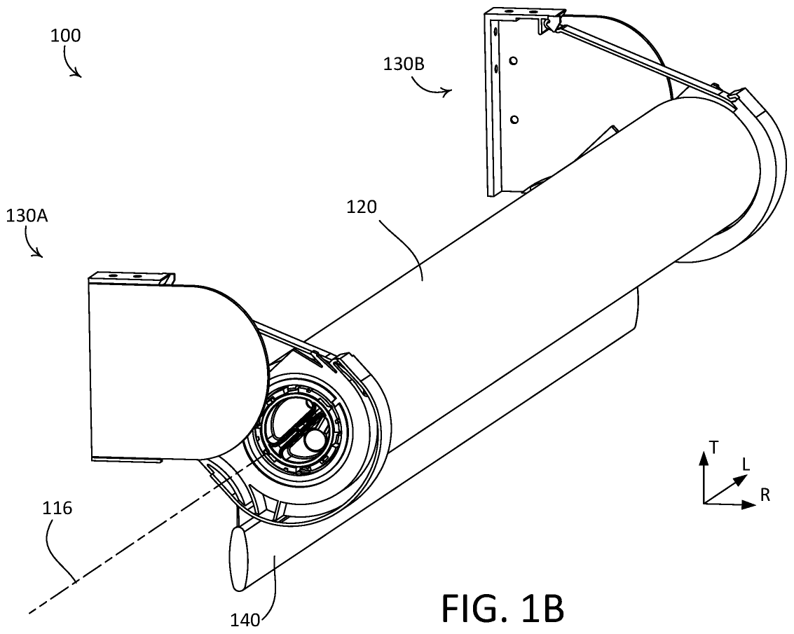

FIGS. 1-3 depict an example motorized window treatment 100 (e.g., a battery-powered motorized window treatment system) that includes a roller tube 110 and a flexible material 120 (e.g., a covering material) windingly attached to the roller tube 110. FIG. 1A depicts the motorized window treatment 100 in an operating position and FIG. 1B depicts the motorized window treatment 100 in an extended position. When in the extended position, batteries of the motorized window treatment 100 may be accessed (e.g., replaced, removed, and/or installed). The motorized window treatment 100 may include a window treatment assembly 111 and one or more mounting brackets 130A, 130B. The window treatment assembly 111 may include a roller tube assembly having a roller tube 110 and a flexible material 120, a drive assembly (e.g., motor drive unit) (not shown), and an idler end portion (not shown). For example, the motorized window treatment 100 may be in an operating position (e.g., a non-extended position) as shown in FIGS. 1-3 or in a non-operating position (e.g., extended position). The motorized window treatment 100 may include first and second mounting brackets 130A, 130B configured to be coupled to or otherwise mounted to a structure surrounding a window. For example, each of the mounting brackets 130A, 130B may be configured to be mounted to (e.g., attached to) a window frame, a wall, or other structure, such that the motorized window treatment 100 is mounted proximate to an opening (e.g., over the opening or in the opening), such as the window for example. The mounting brackets 130A, 130B may be configured to be mounted to a vertical structure (e.g., wall-mounted to a wall as shown in FIG. 1) and/or mounted to a horizontal structure (e.g., ceiling-mounted to a ceiling).

The roller tube 110 may operate as a rotational element of the motorized window treatment 100. The roller tube 110 may be elongate along a longitudinal direction L and rotatably mounted (e.g., rotatably supported) by the mounting brackets 130A, 130B. For example, the window treatment assembly 111 may be rotatably supported by the mounting brackets 130A, 130B. The roller tube 110 may define a longitudinal axis 116. The longitudinal axis 116 may extend along the longitudinal direction L. The mounting brackets 130A, 130B may extend from the structure in a radial direction R. The radial direction R may be defined as a direction perpendicular to the structure and the longitudinal axis 116. The flexible material 120 may be windingly attached to the roller tube 110, such that rotation of the roller tube 110 causes the flexible material 120 to wind around or unwind from the roller tube 110 along a transverse direction T that extends perpendicular to the longitudinal direction L. For example, rotation of the roller tube 110 may cause the flexible material 120 to move between a raised position (e.g., a fully-raised position or a fully-open position as shown in FIGS. 1-3) and a lowered position (e.g., a fully-lowered position or a fully-closed position) along the transverse direction T.

The flexible material 120 may include a first end (e.g., a top or upper end) that is coupled to the roller tube 110 and a second end (e.g., a bottom or lower end) that is coupled to a hembar 140 (e.g., a bottom bar). The hembar 140 may be configured, for example weighted, to cause the flexible material 120 to hang vertically. Rotation of the roller tube 110 may cause the hembar 140 to move toward or away from the roller tube 110 between the raised and lowered positions.

The flexible material 120 may be any suitable material, or made from any combination of materials. For example, the flexible material 120 may be “scrim,” woven cloth, non-woven material, light-control film, screen, and/or mesh. The motorized window treatment 100 may be any type of window treatment. For example, the motorized window treatment 100 may be a roller shade as illustrated, a soft sheer shade, a drapery, a cellular shade, a Roman shade, or a Venetian blind. As shown, the flexible material 120 may be a material suitable for use as a shade fabric and may be alternatively referred to as a flexible material. The flexible material 120 is not limited to shade fabric. For example, in accordance with an alternative implementation of the motorized window treatment 100 as a retractable projection screen, the flexible material 120 may be a material suitable for displaying images projected onto the flexible material.

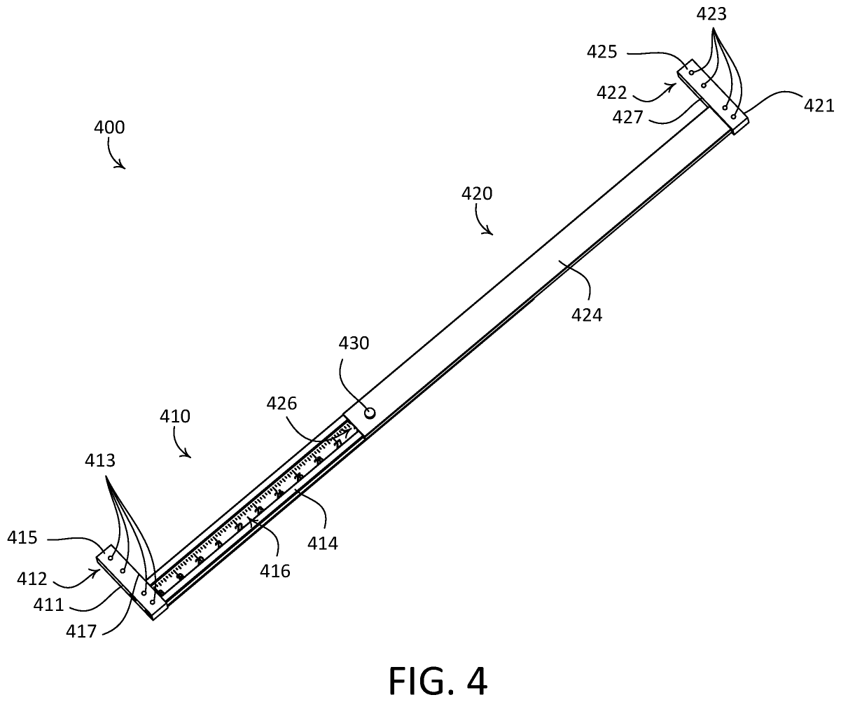

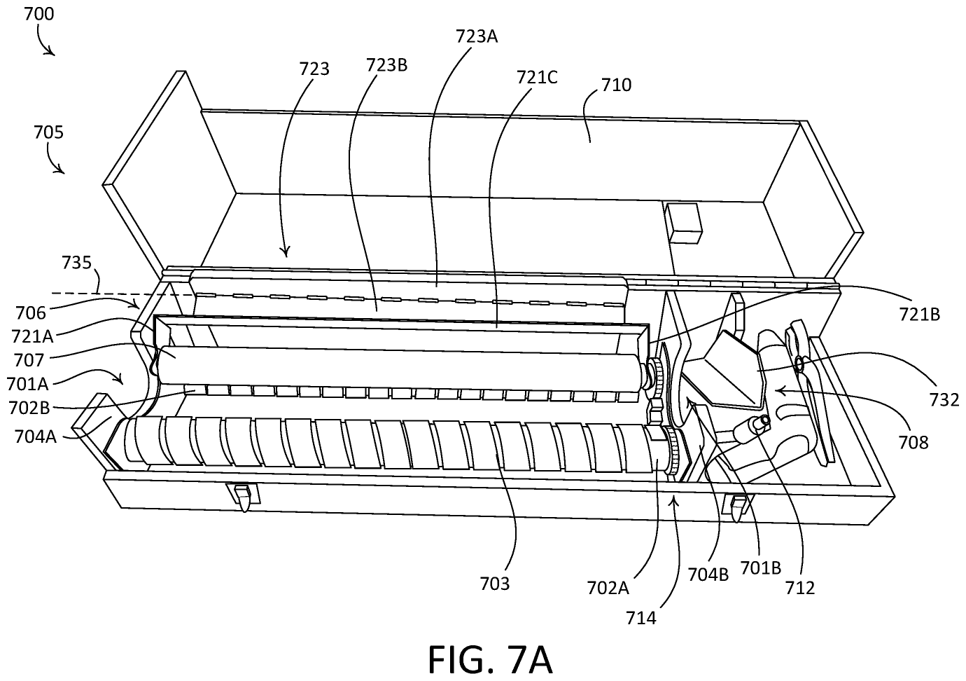

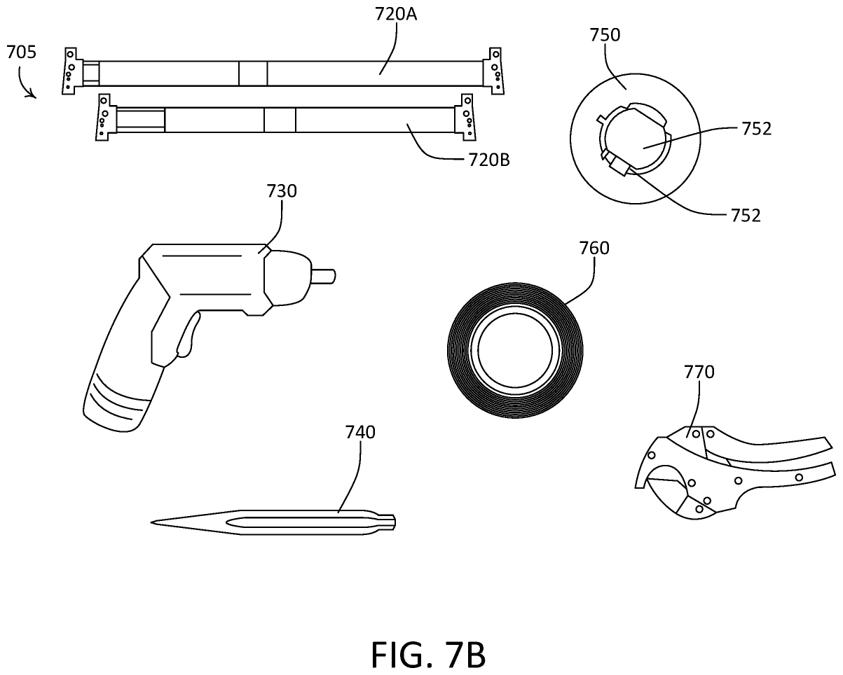

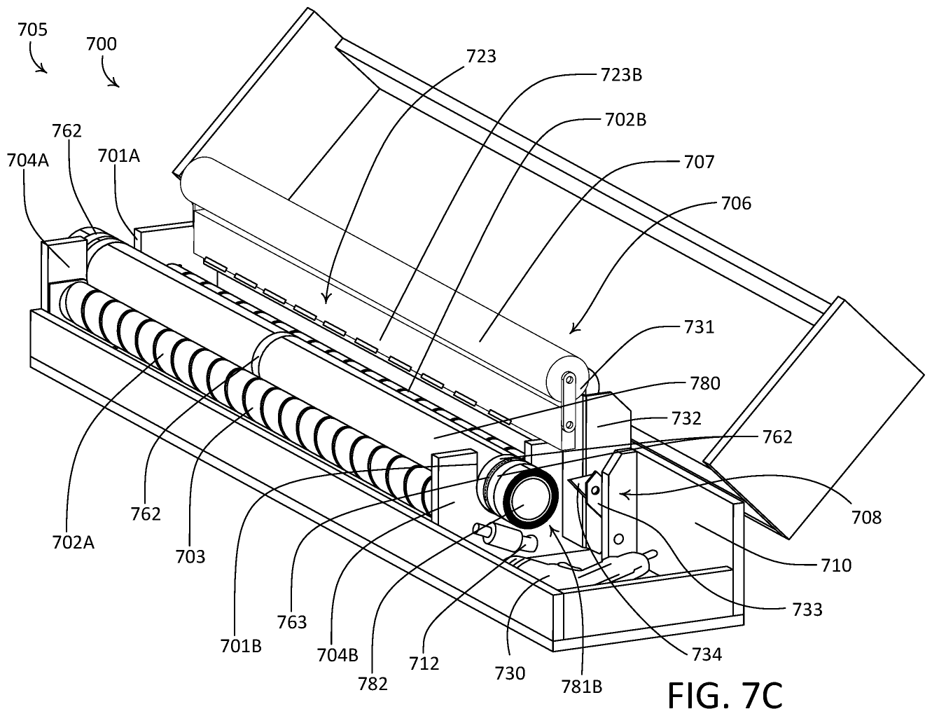

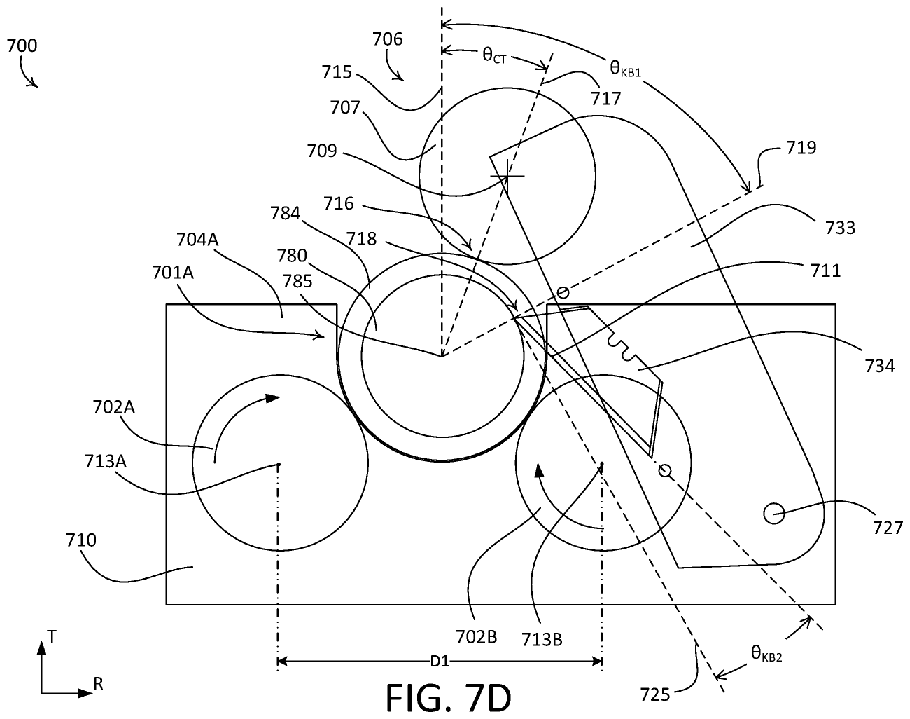

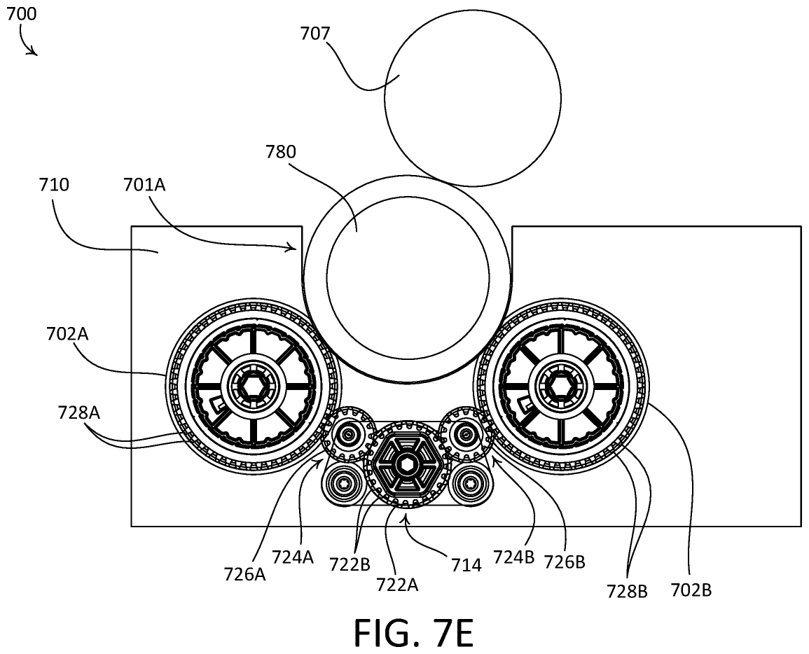

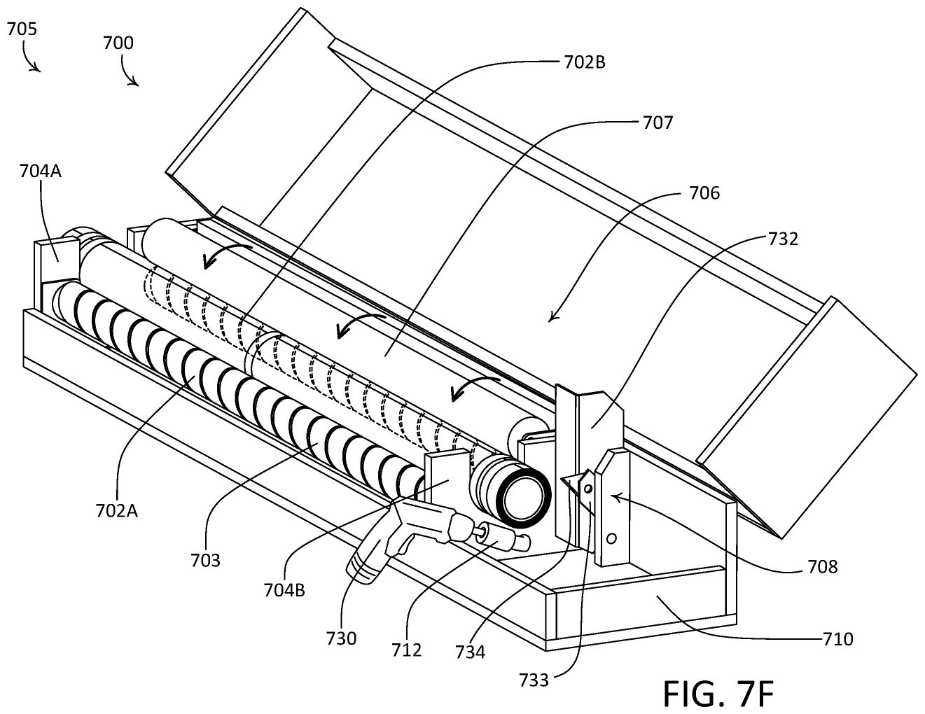

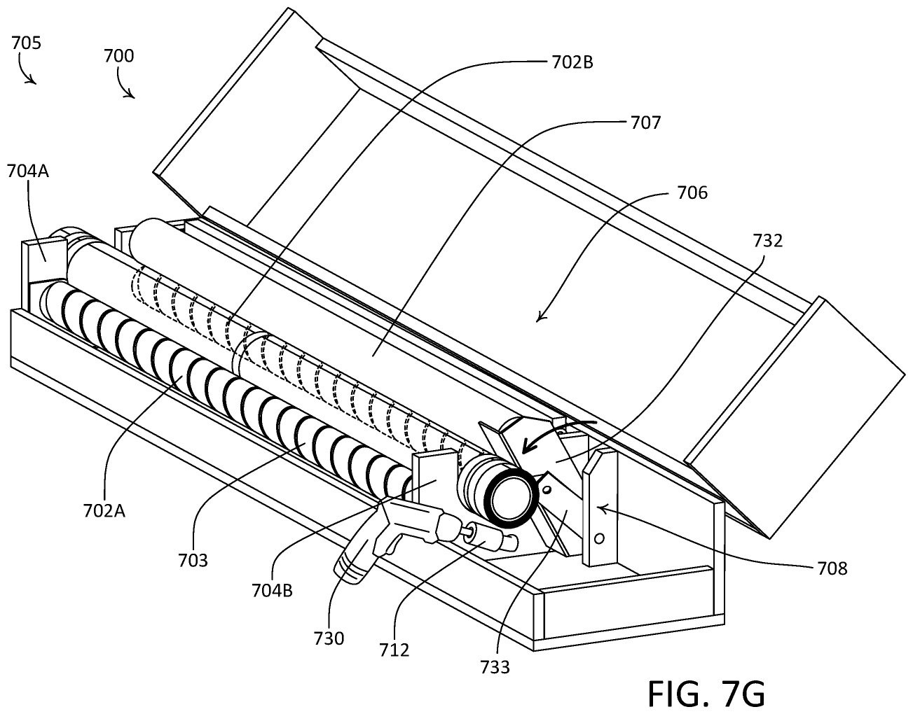

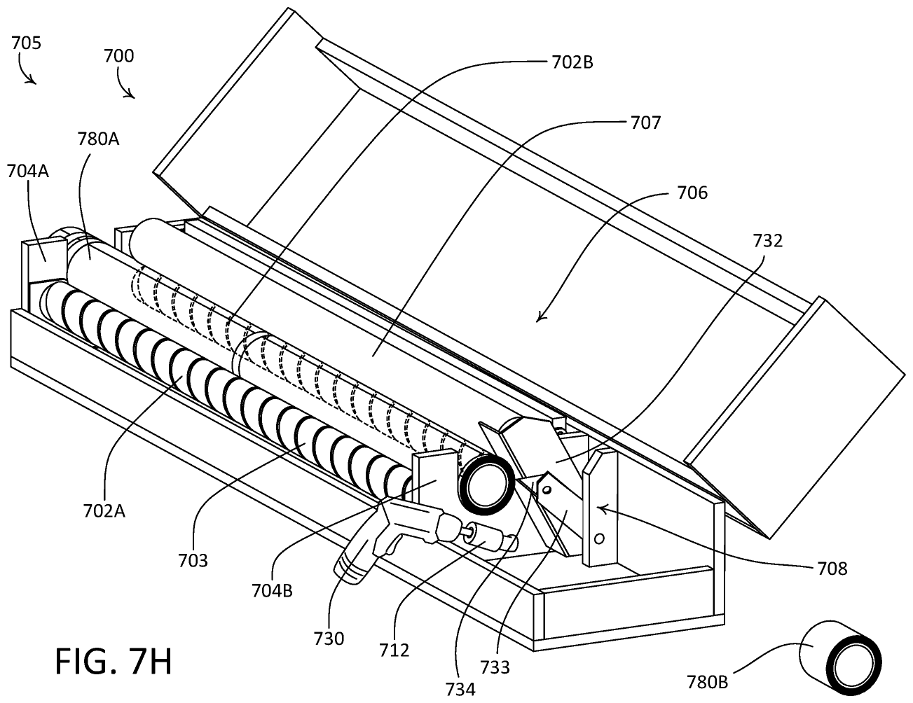

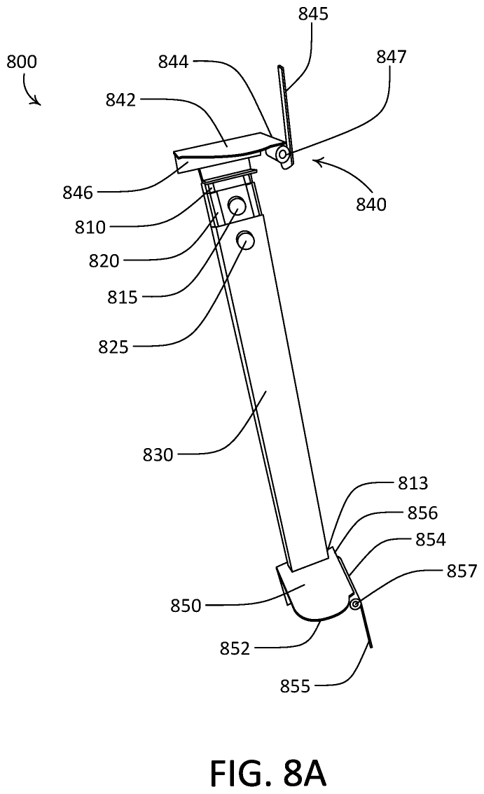

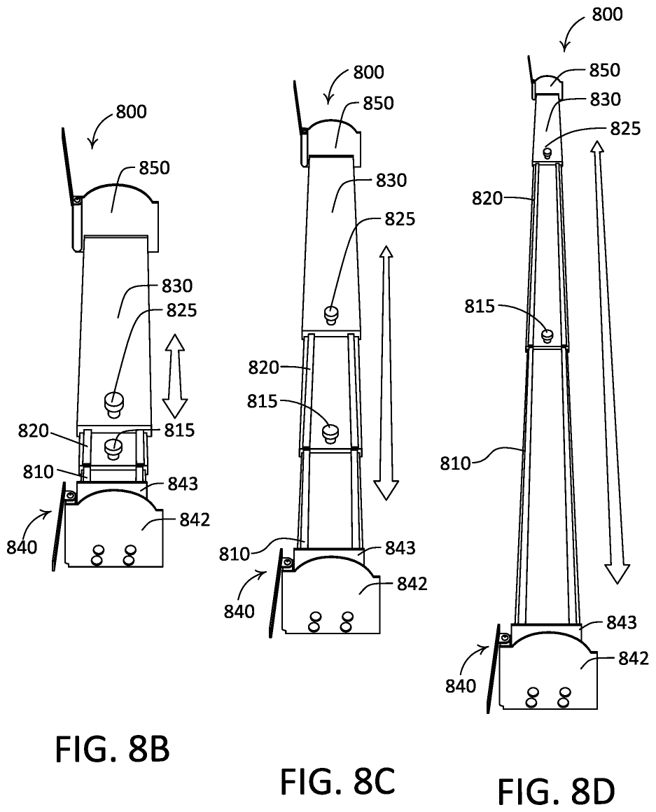

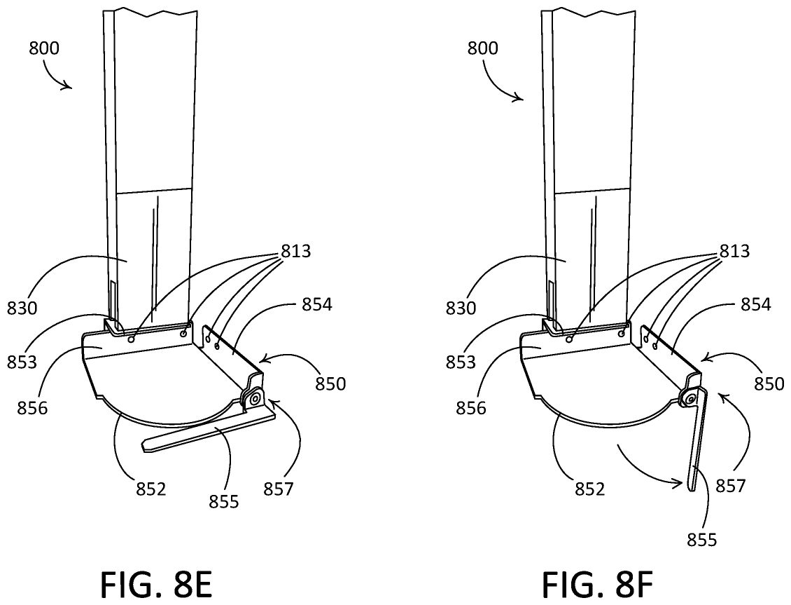

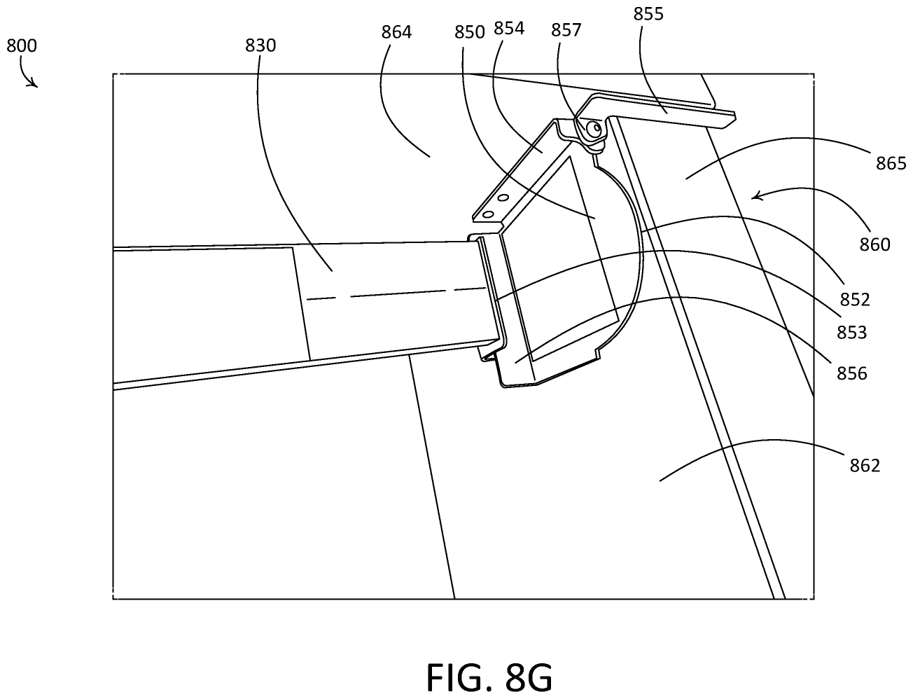

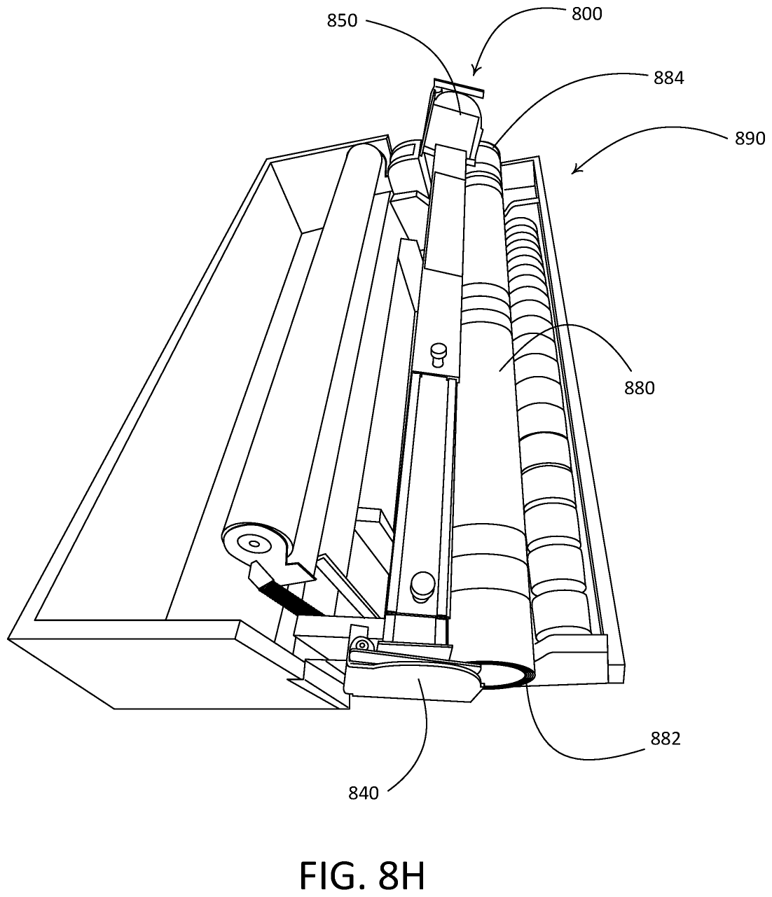

The motorized window treatment 100 may be modified for installation at a specific location. For example, the roller tube assembly (e.g., the roller tube 110 and the flexible material 120) may be cut by a cutting tool (e.g., such as cutting tool 700 shown in FIGS. 7A-7G) at the installation site. A measuring tool (e.g., such as the measuring tool 400 shown in FIGS. 4, 5A, 5B, and 6 and/or the measuring tool 800 shown in FIGS. 8A-8H) may be used to transfer the installation location measurement to the cutting tool and/or roller tube assembly for accurate sizing. Modifying the motorized window treatment 100 at the installation site based on installation location measurements simplifies ordering, manufacturing, and installation processes. And, using the measuring tool ensures that mistakes are not made in measuring the installation location and/or applying the measurement to the roller tube assembly.

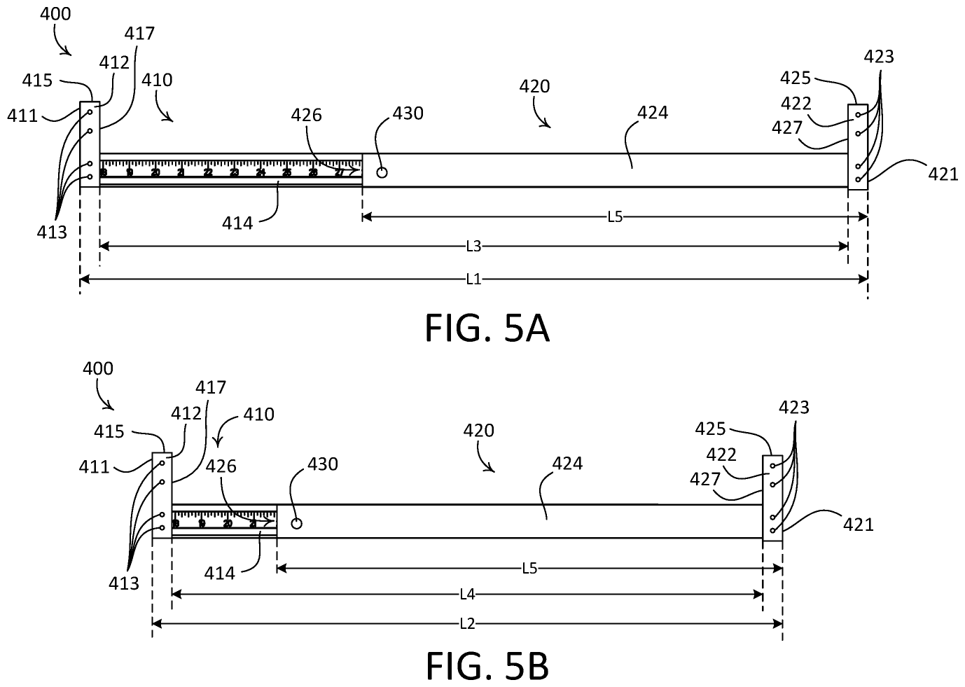

FIGS. 4, 5A, and 5B depict an example measuring tool 400 for use with a motorized window treatment (e.g., such as the motorized window treatment 100 shown in FIGS. 1-3). The measuring tool 400 may be configured to be set at various predetermined lengths that correspond to respective widths of the motorized window treatment (e.g., respective widths of a roller tube assembly of the motorized window treatment). For example, the measuring tool 400 may be used to measure a window casing in which the motorized window treatment is to be installed. The measuring tool 400 may comprise a first portion 410 (e.g., a first end portion), a second portion 420 (e.g., a second end portion), and a fastener 430. The first portion 410 and the second portion 420 may be configured to be adjusted with respect to one another to change an overall length of the measuring tool 400.

The first portion 410 may include a sliding portion 414 and a spacer 412. The spacer 412 may be attached to the sliding portion 414, for example, distal from the second portion 420. The spacer 412 may be configured to represent the location and/or width of a bracket (e.g., such as bracket 130A or bracket 130B shown in FIGS. 1-3) for the motorized window treatment. For example, the spacer 412 may have a width that is the same as the width of the brackets (e.g., such as brackets 130A, 130B shown in FIGS. 1-3) of the motorized window treatment. The spacer 412 may be configured to enable marking of drill holes for the motorized window treatment, for example, for one of the brackets of the motorized window treatment (e.g., such as bracket 130A or bracket 130B shown in FIGS. 1-3). For example, the spacer 412 may define holes 413. The holes 413 may be configured to match fastener locations of the bracket and thus enable marking of fastener locations for the bracket of the motorized window treatment. For example, a punch may be operated through the holes 413 for marking the fastener locations for the respective bracket(s) of the motorized window treatment. The spacer 412 may define an outer face 411 and a front face 415. The sliding portion 414 may be configured to be received by the second portion 420. The first portion 410 (e.g., the sliding portion 414) may include markings 416 (e.g., ruler markings) that indicate the length of the measuring tool 400.

The second portion 420 may include a sliding portion 424 and a spacer 422. The spacer 422 may be attached to the sliding portion 424, for example, distal from the first portion 410. The spacer 422 may be configured to represent the location and/or width of a bracket for the motorized window treatment (e.g., such as bracket 130A or bracket 130B shown in FIGS. 1-3). The spacer 422 may be configured to enable marking of drill holes for the motorized window treatment, for example, for one of the brackets of the motorized window treatment (e.g., such as bracket 130A or bracket 130B shown in FIGS. 1-3). For example, the spacer 422 may define holes 423. The holes 423 may be configured to match fastener locations of the bracket and thus enable marking of fastener locations for the respective bracket(s) of the motorized window treatment. For example, a punch may be operated through the holes 423 for marking the fastener locations for the respective bracket(s) of the motorized window treatment. The spacer 422 may define an outer face 421 and a front face 425. The sliding portion 424 may be configured to receive the first portion 410 (e.g., the sliding portion 414). For example, the sliding portion 414 of the first portion 410 may slidingly engage with the sliding portion 424 of the second portion 420. The sliding portion 414 and the sliding portion 424 may interlock with one another such that they can be slidingly adjusted, for example, to change the overall length of the measuring tool 400. As the sliding portions 414, 424 are slidingly adjusted, the length of the measuring tool 400 may be indicated by the markings 416. For example, a marking at the overlap of the sliding portion 424 and the sliding portion 414 may indicate a length associated with the roller tube assembly (e.g., a length between respective inner surfaces 417, 427 of the spacers 412, 422) for the specific installation location. Alternatively, a marking at the overlap of the sliding portion 424 and the sliding portion 414 may indicate the length associated with the brackets and the roller tube assembly (e.g., a length between respective outer surfaces 411, 421 of the spacers 412, 422) for the specific installation location.

The fastener 430 may be configured to releasably secure the first portion 410 and the second portion 420 to one another. For example, the fastener 430 may prevent movement of the first portion 410 with respect to the second portion 420. The fastener 430 may be received by an aperture (not shown) in the sliding portion 424 of the second portion 420. When tightened, the fastener 430 may be configured to abut the sliding portion 414 of the first portion 410. Friction forces between the fastener 430 and the sliding portion 414 may secure the first portion 410 in its position relative to the second portion 420. For example, the fastener 430 may be configured to prevent the first and second sliding portions 414, 424 from being slidingly adjusted with respect to one another. When the fastener 430 is loosened, the sliding portion 414 may be slidingly adjusted with respect to the sliding portion 424. It should be appreciated that although the figures show the first portion 410 (e.g., the sliding portion 414) with the markings 416, the second portion 420 (e.g., the sliding portion 424) may slide relative to the first portion 410 (e.g., the sliding portion 414) and may include the markings 416 that indicate the length of the measuring tool 400 and/or the length associated with the brackets and/or the roller tube assembly.

The measuring tool 400 may be adjustable to various lengths, for example, as shown in FIGS. 5A and 5B. The various lengths of the measuring tool 400 may correspond to various widths of respective window treatments (e.g., roller tube assemblies). The measuring tool 400 may be adjusted between a first length L1 (e.g., as shown in FIG. 5A) and a second length L2 (e.g., as shown in FIG. 5B) by sliding the first portion 410 (e.g., the sliding portion 414) relative to the second portion 420 (e.g., the sliding portion 424). When the measuring tool 400 is at the first length L1, the roller tube assembly may be sized (e.g., cut) to a width that corresponds to a third length L3. The third length L3 may be set by the distance between the inner surfaces 417, 427 of the respective spacers 412, 422 when the measuring tool 400 is at the first length L1. When the measuring tool 400 is at the second length L2, the roller tube assembly may be sized (e.g., cut) to a width that corresponds to a fourth length L4. The fourth length L4 may be set by the distance between the inner surfaces 417, 427 of the respective spacers 412, 422 when the measuring tool 400 is at the second length L2. The spacers 412, 422 may represent the brackets of the window treatment assembly. And, the third length L3 may represent the first length L1 minus the width of the two spacers 412, 422. The second portion 420 may define a fifth length L5 that is measured from the outer surface 421 to the end of the second portion 420 that overlaps with the first portion 410.

The measuring tool 400 may be adjustable to match different window sizes, for example, such as to fit within casings of windows having different sizes. Although FIGS. 5A and 5B show two example lengths for the measuring tool 400, it should be appreciated that the measuring tool 400 may be adjustable to a plurality of other lengths to accommodate a variety of window sizes. The measuring tool 400 may enable motorized window treatments having roller tube assemblies of one or more widths to be provided (e.g., to a consumer, a dealer, an installer, and/or the like) for installation. The measuring tool 400 may enable the installer to transfer an accurate measurement from a window (e.g., window casing) to a window treatment assembly such that the window treatment assembly can be cut to the measured width. For example, the measuring tool 400 may eliminate measurement error(s) that may occur when a tape measure or similar measuring tool is used to measure the window and apply that measurement to the window treatment assembly.

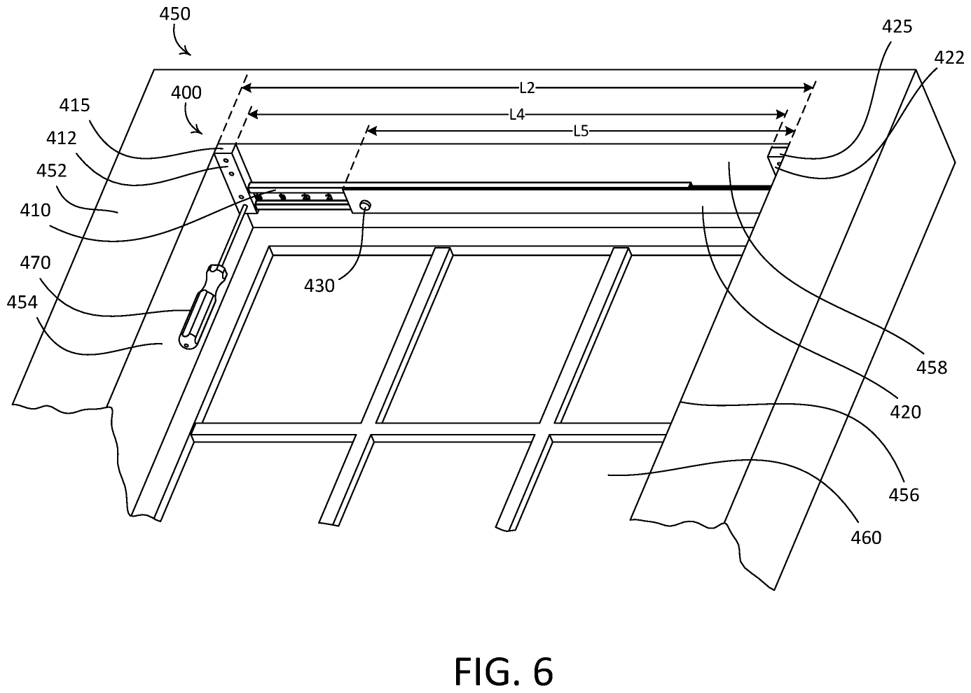

FIG. 6 depicts the measuring tool 400 inside an example window casing 450. The window casing 450 may surround a window 460. When the measuring tool 400 is inside the window casing 450, the spacers 412, 422 may abut opposed sidewalls 454, 456 of the window casing 450. For example, the outer face 411 of the spacer 412 may be configured to abut the sidewall 454 of the window casing 450 and the outer face 421 of the spacer 422 may be configured to abut the sidewall 456 of the window casing 450. The spacers 412, 422 may also abut an upper wall 458 of the window casing 450.

The length of the measuring tool 400 may be adjusted (e.g., to the length L2) such that the outer faces 411, 421 abut the respective sidewalls 454, 456. The length L2 may be defined by the distance between the sidewalls 454, 456 of the window casing 450. For example, the length of the measuring tool 400 may be less than the length L2 (e.g., the length of the measuring tool may be adjusted to fit within the window casing 450) when placed within the window casing 450. The sliding portions 410, 420 may be adjusted to set the length of the measuring tool 400 at the length L2 such that the spacers 412, 422 (e.g., outer faces 411, 412) abut the sidewalls 454, 456 of the window casing 450. The fastener 430 may be tightened when the spacers 412, 422 abut the sidewalls 454, 456 to secure the measuring tool 400 at the length L2 and/or secure the measuring tool 400 within the window casing 450. For example, friction forces between the outer faces 411, 412 and the respective sidewalls 454, 456 may secure the measuring tool 400 within the window casing 450. When the outer faces 411, 421 abut the respective sidewalls 454, 456, a tool 470 (e.g., such as a punch 470) may be used to mark the location of the holes 413 and 423, for example, such that brackets can be properly located and installed for the motorized window treatment. The measuring tool 400 may enable an installer to avoid measurement errors because the measuring tool is set at the proper measurement and can be transferred to a cutting location. That is, use of the measuring tool 400 avoids use of a tape measure (or similar tool) to measure the window casing 450 and then applying that measurement to the window treatment assembly which introduces two instances of possible measurement error. The front faces 415, 425 may be configured to be aligned (e.g., substantially flush) with an outer surface 452 of the window casing 450, for example, to ensure the brackets are installed at a depth that allows access to batteries within the motorized window treatment. For example, the holes 413, 423 in the spacers 412, 422 may be configured to enable the bracket locations to be marked at the depth that allows access to batteries within the motorized window treatment.

Although the measuring tool 400 is shown within the window casing 450 in FIG. 6, it should be appreciated that the measuring tool 400 may be alternatively located with respect to a window, door, or some other feature, such that an associated measurement can be used to cut the motorized window treatment to a size corresponding to the associated measurement.

FIGS. 7A-7H depict an example window treatment cutting tool 700. FIG. 7A is a perspective view of the window treatment cutting tool 700. FIG. 7D is a partial cross-section view of the window treatment cutting tool 700 with an uncut roller tube assembly 780 received thereon. The window treatment cutting tool 700 may be a part of a window treatment cutting tool kit 705 as shown in FIG. 7B. The window treatment cutting tool 700 may comprise a case 710 that is configured to house one or more components of the window treatment cutting tool 700 and/or the window treatment cutting tool kit 705. For example, the window treatment cutting tool kit 705 may include the case 710. The window treatment cutting tool 700 may be configured to cut an uncut roller tube assembly 780 (e.g., to be used as the roller tube assembly of the window treatment assembly 111 that includes the roller tube 110 and the flexible material 120) to a desired width. The uncut roller tube assembly 780 may be a standard width roller tube assembly (e.g., the uncut roller tube assembly 780 may be shipped in a variety of standard widths) that is provided to an installer. For example, the installer may stock roller tube assemblies having a variety of standard widths and may choose the size to use (e.g., and cut) based on the measurement. The window treatment cutting tool 700 may be configured to rotate the uncut roller tube assembly 780 to cut the uncut roller tube assembly 780. The fabric 784 of the uncut roller tube assembly 780 may be secured (e.g., with pieces 762 of tape 760) when the window treatment cutting tool 700 rotates the uncut roller tube assembly 780.

The window treatment cutting tool 700 may be configured to enable accurate cutting of the uncut roller tube assembly 780 at an installation location. For example, an installer may have a plurality of window treatments (e.g., motorized and/or manual window treatments) that are of various widths. A motorized window treatment may be AC-powered or battery-powered. The installer may select a window treatment having a width that is close to a measured length of a window and cut the roller tube assembly of the selected window treatment to the measured length at the installation location. The case 710 may comprise latches, a lid, and one or more handles to enable the window treatment cutting tool 700 to be portable (e.g., brought to the installation location by the installer and removed from the installation location after installation of one or more window treatments).

The window treatment cutting tool 700 may comprise a pair of cylindrical support tubes 702A, 702B, a pair of guide walls 704A, 704B, a clamping assembly 706, a cutting arm assembly 708, and/or an adapter 712. The pair of cylindrical support tubes 702A, 702B may be configured to support the uncut roller tube assembly 780 as it rotates. The pair of cylindrical support tubes 702A, 702B may comprise a first cylindrical support tube 702A and a second cylindrical support tube 702B. One or more of the cylindrical support tubes 702A, 702B may be configured to be driven to rotate the uncut roller tube assembly 780. For example, the first cylindrical support tube 702A and the second cylindrical support tube 702B may be configured to be driven to rotate the uncut roller tube assembly 780. The pair of cylindrical support tubes 702A, 702B may be parallel to one another and spaced apart such that the uncut roller tube assembly 780 is captured between the pair of cylindrical support tubes 702A, 702B. For example, the cylindrical support tube 702A may define a first rotational axis 713A and the cylindrical support tube 702B may define a second rotational axis 713B that is parallel to the first rotational axis 713A (e.g., the first rotational axis 713A and the second rotational axis 713B may lie in the same horizontal plane). The pair of cylindrical support tubes 702A, 702B may define the same diameter and/or may be aligned horizontally within the window treatment cutting tool 700. For example, the cylindrical support tubes 702A, 702B may define respective rotational axes (e.g., such as the first rotation axis 713A and the second rotational axis 713B) that are parallel and aligned horizontally. It should be appreciated that both of the cylindrical support tubes 702A, 702B may be driven (e.g., mechanically coupled to the adapter 712 as described herein) or one of the two cylindrical support tubes 702A, 702B may be driven and the other may be non-driven. It should also be appreciated that although the window treatment cutting tool 700 is shown having a pair of cylindrical support tubes 702A, 702B, the window treatment cutting tool 700 may alternatively be configured by replacing one or more of the pair of cylindrical support tubes 702A, 702B with a plurality of rollers (e.g., shorter tubes aligned along the respective rotational axis) and/or a surface that supports the uncut roller tube assembly 780. It should also be appreciated that one of the two cylindrical support tubes 702A, 702B may be stationary while the other rotates.

The pair of guide walls 704A, 704B may be located at opposed ends of the pair of cylindrical support tubes 702A, 702B. For example, the pair of cylindrical support tubes 702A, 702B may extend from a first guide wall 704A of the pair of guide walls to a second guide wall 704B of the pair of guide walls. For example, the pair of cylindrical support tubes 702A, 702B may be attached to the pair of guide walls 704A, 704B. Each of the pair of guide walls 704A, 704B may define a notch 701A, 701B that is configured to receive the uncut roller tube assembly 780. The notch 701A, 701B may be configured to align the uncut roller tube assembly 780 with the cutting arm assembly 708. For example, the notch 701A, 701B may maintain alignment of the uncut roller tube assembly 780 on the pair of cylindrical support tubes 702A, 702B as the uncut roller tube assembly 780 rotates (e.g., with blade 734 of the cutting arm assembly 708 engaged with the fabric 784 of the uncut roller tube assembly 780). The cylindrical support tubes 702A, 702B may be laterally spaced by a distance DI that allows the notches 701A, 701B and the cylindrical support tubes 702A, 702B to physically support the uncut roller tube assembly 780.

The clamping assembly 706 may comprise a clamping tube 707. The clamping tube 707 may be configured to rotate. For example, the clamping tube 707 may rotate in response to rotation of the uncut roller tube assembly 780 as one or both of the cylindrical support tubes 702A, 702B are driven. The clamping assembly 706 may be configured to be operated to removably secure the uncut roller tube assembly 780 within the window treatment cutting tool 700. For example, the clamping assembly 706 may pivot to abut the fabric 784 of the uncut roller tube assembly 780 such that the clamping roller tube 706 applies a force on the uncut roller tube assembly 780 to secure the uncut roller tube assembly 780 within the window treatment cutting tool 700. For example, the clamping assembly 706 may comprise a hinge 723. The clamping assembly 706 may be operated (e.g., manually operated) between an open position and a closed or cutting position. The clamping assembly 706 may be in the open position when the uncut roller tube assembly 780 is installed and removed from the window treatment cutting tool 700. The clamping assembly 706 may be in the cutting position when the uncut roller tube assembly 780 is being cut by the window treatment cutting tool 700.

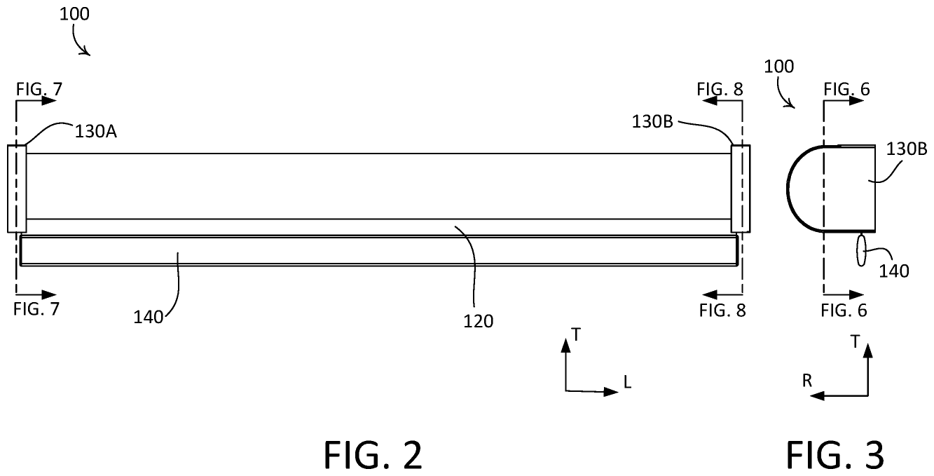

The clamping tube 707 may abut the fabric 784 of the uncut roller tube assembly 780 when the clamping assembly 706 is in the cutting position. For example, the clamping tube 707 may be configured to apply a force (e.g., maintain pressure) on the uncut roller tube assembly 780 when the clamping assembly 706 is in the cutting position. For example, the clamping assembly 706 may maintain pressure on the uncut roller tube assembly 780 as the uncut roller tube assembly 780 rotates within the window treatment cutting tool 700. When in the cutting position and thereby securing the uncut roller tube assembly 780, the clamping assembly 706 may prevent movement (e.g., horizontal and/or angular movement) of the uncut roller tube assembly 780 within the window treatment cutting tool 700 such that the cutting arm assembly 708 remains aligned with an intended cut line (e.g., a location on the uncut roller tube assembly 780 that indicates the desired length). The clamping tube 707 may be positioned off center from the top (e.g., 0 degrees from the vertical plane 715) of the uncut roller tube assembly 780 when in the cutting position. The clamping tube 707 may contact the uncut roller tube assembly 780 at a contact location 716 that is offset (e.g., angularly offset) from a vertical plane 715 defined by the uncut roller tube assembly 780. The vertical plane 715 may be defined by the transverse direction T and the longitudinal direction L, as shown in FIGS. 1 and 2. The uncut roller tube assembly 780 may be aligned with the vertical plane 715. For example, the vertical plane 715 may extend through a rotational axis 785 of the uncut roller tube assembly 780 (e.g., such as the longitudinal axis 116 shown in FIG. 1). The vertical plane 715 may extend an equal distance (e.g., in the radial direction R) from the rotational axes 713A, 713B of the cylindrical support tubes 702A, 702B. The clamping tube 707 may abut the uncut roller tube assembly 780 at the contact location 716 that is offset from the vertical plane 715 by an offset angle θ_{CT}. The offset angle θ_{CT} may be greater than 0 degrees. The offset angle θ_{CT} may be between 5 and 30 degrees from the vertical plane 715. It should be appreciated that the offset angle θ_{CT} may be about 5 degrees, slightly less than 5 degrees, about 30 degrees, or slightly greater than 30 degrees. For example, the clamping tube 707 may be configured such that a first offset plane 717 that extends through a rotational axis 709 of the clamping tube 707 and the rotational axis 785 of the uncut roller tube assembly 780 is offset from the vertical plane 715 by the offset angle θ_{CT}.

The clamping assembly 706 may be pivotally attached to the window treatment cutting tool 700 (e.g., the case 710). For example, the clamping assembly 706 may include pivot arms 721A, 721B and the hinge 723. The pivot arms 721A, 721B may be configured to attach the clamping tube 707 to the hinge 723. The pivot arms 721A, 721B may be connected together via a pivot bar 721C. The hinge 723 may define a first leaf 723A that is secured to the case 710 and a second leaf 723B that is coupled to the pivot bar 721C (e.g., and thus to the pivot arms 721A, 721B). The hinge 723 may define a pivot axis 735 about which the clamping tube 707 pivots. The clamping assembly 706 (e.g., the hinge 723 and/or the pivot arms 721A, 721B) may enable the clamping tube 707 to engage roller tubes having different diameters. The clamping assembly 706 may be configured to be secured in the open position and the cutting position. For example, the clamping assembly 706 may comprise an over-center spring mechanism 731 that is configured to secure the clamping assembly 706 (e.g., the clamping tube 707) in the open and secured positions. It should be appreciated that the window treatment cutting tool 700 (e.g., the clamping assembly 706) may comprise alternate securing means to maintain pressure on the uncut roller tube assembly 780 during cutting. It should be appreciated that although the hinge 723 is shown in the figures as a piano hinge, the hinge 723 is not limited to a piano hinge and instead may be another hinge type, for example, such as one or more butt hinges, one or more barrel hinges, one or more concealed hinges, one or more pivot hinges, one or more overlay hinges, and/or one or more strap hinges.

A foam wrap 703 (e.g., a rubber wrap, neoprene wrap, friction tape, etc.) may be applied to one or more of the pair of cylindrical support tubes 702A, 702B. The foam wrap 703 may be configured to increase friction between the fabric 784 of the uncut roller tube assembly 780 and one or both of the cylindrical support tubes 702A, 702B. For example, the friction wrap 703 may be configured to transfer rotation of one or both of the cylindrical support tubes 702A, 702B to the uncut roller tube assembly 780. The foam wrap 703 may be configured to evenly distribute pressure on the fabric 784 of the uncut roller tube assembly 780 from the cylindrical support tubes 702A, 702B and the clamping tube 707.

The cutting arm assembly 708 may comprise a blade support member 732, a blade holder 733, and a blade 734. The blade support member 732 may be an upper plate. The blade support member 732 may be configured to be pressed toward the uncut roller tube assembly 780 by a user such that the blade 734 engages and cuts the uncut roller tube assembly 780 (e.g., successive layers of the fabric 784 and/or the roller tube 782). For example, the cutting arm assembly 708 may be operated by the user when the uncut roller tube assembly 780 is secured within the window treatment cutting tool 700 by the clamping assembly 706 (e.g., secured between the clamping tube 707 and the cylindrical support tubes 702A, 702B. The blade 734 may be configured to cut the fabric 784 and the roller tube 782 of the uncut roller tube assembly 780. The cutting arm assembly 708 may be pivotally attached to the case 710. The cutting arm assembly 708 may be attached to the case 710 at a pivot axis 727. For example, the cutting arm assembly 708 may be configured to pivot (e.g., about the pivot axis 727) toward and away from the uncut roller tube assembly 780 that is received within the notches of the guide walls 704A, 704B. For example, the cutting arm assembly 708 may be configured to pivot toward the uncut roller tube assembly 780 that is received within the notches of the guide walls 704A, 704B and supported by the pair of cylindrical support tubes 702A, 702B as a force is manually applied to the cutting arm assembly 708 (e.g., the upper plate). In some cases, the window may be smaller than the length of the distance between the guide walls 704A, 704B, and in those cases, the uncut roller tube assembly 780 may not be received in both notches of the guide walls 704A, 704B (e.g., just in the notch in the guide wall 704B).

The blade 734 may be configured to contact an outer layer of fabric 784 of the uncut roller tube assembly 780 when the cutting arm assembly 708 (e.g., the upper plate) is biased toward the uncut roller tube assembly 780. The blade 734 may be configured to be replaced (e.g., when the blade 734 becomes dull and/or for different types of fabrics). The blade 734 may comprise a utility knife blade, a razor blade, or some other type of blade. With the uncut roller tube assembly 780 rotating, the cutting arm assembly 708 may be pressed toward the uncut roller tube assembly 780 such that the blade 734 is biased at an angle towards the rolling tube assembly 780 (e.g., rather than directly from the top). For example, the blade 734 may be angled such that the blade 734 abuts the fabric 784 of the uncut roller tube assembly 780 at an angle between approximately 0 and 90 degrees (e.g., when the cutting arm assembly 708 is pressed toward the uncut roller tube assembly 780). The blade 734 may be positioned off-center from the top (e.g., approximately 0 degrees) of the uncut roller tube assembly 780.

The blade 734 may contact the uncut roller tube assembly 780 at a contact location 718 that is offset (e.g., angularly offset) from the vertical plane 715 defined by the uncut roller tube assembly 780 in the plane that is defined by the transverse direction T and the radial direction R. As shown in FIG. 7D, the contact location 718 may be defined as the location where the blade 734 contacts the fabric 784 or the roller tube 782 of the uncut roller tube assembly 780. The contact location 718 may be offset from the vertical plane 715. For example, a second offset plane 719 may extend through the rotational axis 785 and the contact location 718. The second offset plane 719 may extend in the longitudinal direction L. The second offset plane 719 may be offset from the vertical plane 715 by an offset angle θ_{KB1}. The blade 734, when oriented at the offset angle θ_{KB1}, may be configured such that the force manually applied to the cutting arm assembly 708 does not push the uncut roller tube assembly 780 out of engagement with the pair of cylindrical support tubes 702A, 702B. For example, the blade 734, when oriented at the offset angle θ_{KB1}, may be configured such that the uncut roller tube assembly 780 remains engaged with the pair of cylindrical support tubes 702A, 702B as the force is manually applied to the cutting arm assembly 708 (e.g., as the blade 734 cuts the uncut roller tube assembly 780). For example, the offset angle θ_{KB1} may be between 45 and 65 degrees, about 45 degrees, or about 65 degrees. It should be appreciated that the offset angle θ_{KB1} is not limited to the range between 45 and 65 degrees; rather, the offset angle θ_{KB1} may be less than 45 degrees or greater than 65 degrees provided that the uncut roller tube assembly 780 remain engaged with the pair of cylindrical support tubes 702A, 702B as the force is applied to the cutting arm assembly. If the blade 734 abuts the uncut roller tube assembly 780 at a contact location 718 that is too close to the vertical plane 715 at the top of the uncut roller tube assembly 780 (e.g., with an offset angle θ_{KB1} of approximately 90 degrees) may result in instability of the uncut roller tube assembly 780 in the window treatment cutting tool 700.

The blade 734 itself may be oriented at an offset angle θ_{KB2} with respect to a tangent line 725 of the uncut roller tube assembly 780 at the contact location 718 between the blade 734 and the uncut roller tube assembly 780. For example, a cutting edge 711 of the blade 734 may be angled away from a direction that is parallel to the tangent line 725 at the contact location 718 of the blade 734 and the uncut roller tube assembly 780 by the offset angle θ_{KB2}. For example, the offset angle θ_{KB2} may be between 10 and 30 degrees from the tangent line 725 at the contact location 718 between the blade 734 and the uncut roller tube assembly 780. It should be appreciated that the offset angle θ_{KB2} is not limited to the range of 10 to 30 degrees; rather, the offset angle θ_{KB2} may be less than 10 degrees or greater than 30 degrees provided that the blade 734 does not puncture the roller tube 782 when the force is applied to the cutting arm assembly 708. The blade 734, when oriented at the offset angle θ_{KB1}, may be configured to reduce drag friction between the blade 734 and the uncut roller tube assembly 780. The blade 734, when oriented at the offset angle θ_{KB2}, may also be configured to prevent the blade 734 from puncturing the roller tube 782 of the uncut roller tube assembly 780 and getting stuck in the uncut roller tube assembly 780 (e.g., the roller tube 782 of the uncut roller tube assembly 780).

The adapter 712 may be operatively coupled to one or more of the cylindrical support tubes 702A, 702B. The adapter 712 may be configured to transfer rotation (e.g., of a drill) to the one or more cylindrical support tubes 702A, 702B. For example, the adapter 712 may be configured to receive a chuck of the drill 730. It should be appreciated that the adapter 712 may transfer rotation from other mechanisms, for example, such as a hand crank (not shown). It should be appreciated that the adapter 712 may be configured to receive one or more screw drive configurations (e.g., such as Phillips, hex, torx, etc.). The adapter 712 may be configured to transfer rotation at a 90-degree angle. The adapter 712 may be rotated by the drill 730 and may transfer that rotation to the one or more cylindrical support tubes 702A, 702B. The window treatment cutting tool 700 may comprise a gear assembly 714 that is operatively engaged with one or more of the cylindrical support tubes 702A, 702B. The adapter 712 may be operatively coupled with the gear assembly 714 such that the gear assembly 714 transfers rotation (e.g., of the drill) to one or more of the cylindrical support tubes 702A, 702B.

The gear assembly 714 may comprise a drive gear 722A and a pair of driven gears 724A, 724B. The adapter 712 may be operatively coupled to the drive gear 722A. The driven gear 724A may be operatively coupled to the cylindrical support tube 702A and the driven gear 724B may be operatively coupled to the cylindrical support tube 702B. The drive gear 722A may define a plurality of teeth 722B. The driven gear 724A may define a plurality of teeth 726A. The driven gear 724B may define a plurality of teeth 726B. The teeth 722B of the drive gear 722A may engage the teeth 726A, 726B of the driven gears 724A, 724B such that rotation of the drive gear 722A is transferred to the driven gears 724A, 724B. The cylindrical support tubes 702A, 702B may define respective portions with teeth 728A, 728B. The teeth 726A of the driven gear 724A may engage the teeth 728A defined by the cylindrical support tube 702A, for example, such that rotation of the drive gear 722A is transferred to the cylindrical support tube 702A via the driven gear 724A. The teeth 726B of the driven gear 724B may engage the teeth 728B defined by the cylindrical support tube 702B, for example, such that rotation of the drive gear 722A is transferred to the cylindrical support tube 702B via the driven gear 724B. The gear assembly 714 may be configured such that the cylindrical support tubes 702A, 702B rotate in the same direction and the same rotational speed. For example, the gear assembly 714 may be configured such that one or both of the cylindrical support tubes 702A, 702B rotate in the clockwise direction when viewed from the guide wall 704A, as shown in FIG. 7D.

It should be appreciated that although the figures show a pair of driven gears 724A, 724B, the gear assembly 714 may comprise more or less driven gears between the drive gear 722A and the cylindrical support tubes 702A 702B.

It should be appreciated that although the figures show a pair of cylindrical support tubes 702A, 702B, the window treatment cutting tool 700 may comprise more or less than two cylindrical support tubes. For example, one of the cylindrical support tubes 702A, 702B may be replaced by another support mechanism such as an arm, a wheel, a bar, etc. It should be appreciated that although the figures show the pair of cylindrical support tubes 702A, 702B having the same diameter, the pair of cylindrical support tubes 702A, 702B may have different diameters. It should be appreciated that although the figures show the pair of cylindrical support tubes 702A, 702B extending the full distance between the guide walls 704A, 704B, one or more of the cylindrical support tubes 702A, 702B may extend only a portion of the distance between the guide walls 704A, 704B. It should be appreciated that although the figures show the pair of cylindrical support tubes 702A, 702B aligned vertically, the cylindrical support tubes 702A, 702B may be misaligned vertically.

FIG. 7B depicts example components of the window treatment cutting tool kit 705. FIG. 7C is a perspective view of the window treatment cutting tool 700 with the uncut roller tube assembly 780 received therein. FIG. 7E is another partial cross-section view of the window treatment cutting tool 700 with the uncut roller tube assembly 780 received therein. FIG. 7F is a perspective view of the window treatment cutting tool 700 with the uncut roller tube assembly 780 received thereon and the clamping assembly 706 in a cutting position. FIG. 7G is a perspective view of the window treatment cutting tool 700 with the uncut roller tube assembly 780 received thereon and the blade 734 of the cutting arm assembly 708 cutting the uncut roller tube assembly 780. FIG. 7H is another perspective view of the example window treatment cutting tool 700 with the uncut roller tube assembly 780 having been cut into a first portion 780A and a second portion 780B.

The window treatment cutting tool kit 705 may be an assembly that comprises the window treatment cutting tool 700 (e.g., with the case 710), one or more measuring tools 720A, 720B, a drill 730, a punch 740, a drive assembly aid 750, a roll of tape 760, and/or a hembar cutting tool 770.

The one or more measuring tools 720A, 720B (e.g., such as the measuring tool 400 shown in FIGS. 4-6 and/or the measuring tool 800 shown in FIGS. 8A-8F) may be provided for measuring a variety of window widths. For example, the window treatment cutting tool kit 705 may comprise a first measuring tool 720A for measuring windows having widths in a first range and a second measuring tool 720B for measuring windows having widths in a second range. For example, the first measuring tool 720A may be used to measure windows greater than a threshold width and the second measuring tool 720B may be used to measure windows less than or equal to the threshold width.

The drill 730 may be configured to interface with and rotate the adapter 712. For example, the drill 730 may comprise a chuck that is configured to receive a portion of the adapter 712. The drill 730 may be battery-operated such that the window treatment cutting tool 700 may be used without the need for external power.

The punch 740 (e.g., such as the tool 470) may be configured to mark, in the structure to which the window treatment is to be mounted, the location of fasteners for brackets to mount the cut roller tube assembly. For example, the punch may be configured to mark the location of the fasteners through the first measuring tool 720A or the second measuring tool 720B.

The drive assembly aid 750 may be configured to enable installation of a drive assembly (e.g., motor drive unit) within the cut roller tube assembly (e.g., within the roller tube 782 of the cut roller tube assembly). For example, the drive assembly aid 750 may enable installation of the drive assembly within a roller tube assembly that has been cut to size at an installation location. The drive assembly aid 750 may be inserted onto the end of the drive assembly to ensure alignment with the roller tube 782. The drive assembly may be inserted into the roller tube 782 and a force may be applied to the drive assembly aid 750 to install the drive assembly into the roller tube 782. The drive assembly aid 750 may be configured to apply pressure at a plurality of locations on an end of the drive assembly as the drive assembly is pressed into the roller tube 782. The drive assembly aid 750 may comprise a plurality of portions 752 that are configured to align with corresponding portions of the end of the drive assembly. The drive assembly aid 750 may be configured such that the drive assembly can be installed within the roller tube 782 without adversely effecting operation of a bearing of the drive assembly. The bearing may be configured to support a rotor of the drive assembly, for example, as the rotor rotates. For example, the drive assembly aid 750 may ensure the bearing remains loose on the rotor as the drive assembly is installed within the roller tube 782.

The roll of tape 760 may be configured to secure the fabric 784. For example, pieces 762 of the tape 760 may be applied at various locations on the uncut roller tube assembly 780 to ensure the fabric 784 remains secured as the uncut roller tube assembly 780 is cut by the window treatment cutting tool 700. As shown in FIG. 7C, the pieces 762 of the tape 760 may be applied on either side of the intended cut line 763 to secure the fabric 784 on the discarded portion of the uncut roller tube assembly 780 and the to be installed portion of the roller tube assembly (e.g., the cut roller tube assembly).

The hembar cutting tool 770 may be configured to cut a hembar (e.g., such as the hembar 140 shown in FIGS. 1-3) of the uncut roller tube assembly 780. The hembar may be cut by the hembar cutting tool 770 and then attached to the fabric 784 of the cut roller tube assembly (e.g., after the uncut roller tube assembly 780 is cut using the window treatment cutting tool 700). It should be appreciated that the hembar may be removed from the fabric 784 if the hembar is attached to the fabric 784 when shipped or the hembar may be shipped unattached to the fabric 784.

The window treatment cutting tool 700 may be used to cut the uncut roller tube assembly 780 to a length that corresponds with a measured width of a window. The uncut roller tube assembly 780 may comprise a fabric-wrapped roller tube 782. For example, the uncut roller tube assembly 780 may comprise a roller tube 782 (e.g., such as the roller tube 110 shown in FIG. 1) and fabric 784 (e.g., such as the flexible material 120 shown in FIGS. 1 and 2) wrapped around the roller tube 782. The roller tube 782 may be made of cardboard such that the blade 734 can cut the roller tube 782. The window treatment cutting tool 700 may be configured to cut the fabric 784 and then the roller tube 782 of the uncut roller tube assembly 780 such that the fabric 784 and the roller tube 782 may be cut at the same time. The interior of the roller tube 782 may be empty. For example, the roller tube 782 may not have a drive assembly or an idler installed therein. The uncut roller tube assembly 780 may define a first end 781A and an opposed second end 781B (see FIG. 7C). The uncut roller tube assembly 780 may be received by the guide walls 704A, 704B and the cylindrical support tubes 702A, 702B, as shown in FIG. 7C. It should be appreciated that the guide walls 704A, 704B may support the uncut roller tube assembly 780 and/or the guide walls 704A, 704B may allow the uncut roller tube assembly 780 to extend beyond the cylindrical support tubes 702A, 702B (e.g., and beyond the case 710).

When the uncut roller tube assembly 780 is received by the notches 701A, 701B of the guide walls 704A, 704B and is received by the cylindrical support tubes 702A, 702B, the measuring tool 720A, 720B may be positioned on the uncut roller tube assembly 780. The uncut roller tube assembly 780 may be positioned in the window treatment cutting tool 700. The measuring tool 720A, 720B may be positioned between the blade 734 and the first end 781A of the uncut roller tube assembly 780. The measuring tool 720A, 720B may be positioned to abut the uncut roller tube assembly 780 at the first end 781A. The intended cut line 763 may be marked on the uncut roller tube assembly 780. At the inner surface 427 of measuring tool 720A, 720B. The clamping assembly 706 may be operated to secure the uncut roller tube assembly 780 such that the blade remains aligned with the intended cut line 763. When the clamping assembly 706 is in the secured position, the cutting arm assembly 708 may be pivoted toward the uncut roller tube assembly 780 until the blade 734 contacts the fabric 784 (e.g., such as the flexible material 120 shown in FIGS. 1 and 2) that is wound around the roller tube 782.

When an edge 729 of the blade 734 is in contact with the fabric 784, the drill 730 may be operated to rotate the uncut roller tube assembly 780. Because of the clamping assembly 706, the outer layer of fabric 784 of the uncut roller tube assembly 780 may remain in contact with the cylindrical support tubes 702A, 702B as the drill 730 is operated to rotate the uncut roller tube assembly 780. A force may be applied to the cutting arm assembly 708 (e.g., the upper plate) as the uncut roller tube assembly 780 is rotated to cut successive layers of fabric 784 and the roller tube 782 until the uncut roller tube assembly 780 is separated (e.g., cut) into a first portion 780A (e.g., a to-be-installed portion) and a second portion 780B (e.g., a leftover or discarded portion). The first portion 780A may define a length equal to the length of the measuring tool 720A, 720B (e.g., that indicates the measured width of the window, such as length L3 or L4 shown in FIGS. 5A and 5B). The second portion 780B may define a length equal to the length of the uncut roller tube assembly 780 minus the measured length. The first portion 780A (e.g., the cut roller tube assembly) may be removed from the window treatment cutting tool 700 and installed in the desired mounting location when the drive assembly and idler are installed therein, as described herein.

FIGS. 8A-8F depict another example measuring tool 800 for use with a motorized window treatment (e.g., such as the motorized window treatment 100 shown in FIGS. 1-3). The measuring tool 800 may be configured to be set at various predetermined lengths that correspond to respective widths of various motorized window treatments (e.g., respective widths of roller tube assemblies of various motorized window treatments). For example, the measuring tool 800 may be used to measure the width of a window casing in which the motorized window treatment is to be installed. The measuring tool 800 may comprise a first portion 810 (e.g., a first end portion), a second portion 820 (e.g., an intermediate portion), a third portion 830 (e.g., a second end portion), a first bracket portion 840, and a second bracket portion 850. The first portion 810, the second portion 820, and the third portion 830 may be configured to be adjusted with respect to one another to change an overall length of the measuring tool 800.

The first portion 810 may be attached to the first bracket portion 840. The third portion 830 may be attached to the second bracket portion 850. The first bracket portion 840 and second bracket portion 850 may be configured to represent the respective brackets of the motorized window treatment (e.g., such as bracket 130A or bracket 130B shown in FIGS. 1-3). The first bracket portion 840 and second bracket portion 850 may be configured to enable marking of drill holes for the motorized window treatment, for example, for one of the brackets of the motorized window treatment. The first and second bracket portions 840, 850 may define an outer wall 842, 852; an upper wall 844, 854; and a rear wall 846, 856. The outer wall 842, 852 may be configured to be proximate to (e.g., abut) a window casing (e.g., inside surfaces of the window casing) when the measuring tool 800 is placed within a window casing. The outer wall 842, 852 may be configured to represent an outline of the brackets of the motorized window treatment. The upper wall 844, 854 may be configured to be proximate to (e.g., abut) an upper surface of the window casing and/or a ceiling surface. The rear wall 846, 856 may be configured to be proximate to (e.g., abut) a rear surface of the window casing and/or a wall surface. The upper wall 844, 854 and/or the rear wall 846, 856 may define holes 813. The holes 813 may be configured to mark fastener locations for the bracket of the motorized window treatment. For example, the holes 813 may match the locations of bracket holes. For example, a punch may be operated through the holes 813 for marking the fastener locations for the respective bracket(s) of the motorized window treatment.

The first portion 810 may be configured to be received by the second portion 820. The second portion 820 may be configured to be received by the third portion 830. For example, the first portion 810 may slidingly engage with the second portion 820 and the second portion 820 may slidingly engage with the third portion 830. The first portion 810 and the second portion 820 may interlock with one another and the second portion 820 and the third portion 830 may interlock with one another such that the portions 810, 820, 830 can be slidingly adjusted, for example, to change the overall length of the measuring tool 800.

The measuring tool 800 may comprise a first fastener 815 and a second fastener 825. The first fastener 815 may be configured to releasably secure the first portion 810 and the second portion 820 to one another. For example, the first fastener 815 may prevent movement of the first portion 810 with respect to the second portion 820. The first fastener 815 may be received by an aperture (not shown) in the second portion 820. When tightened, the first fastener 815 may be configured to abut the first portion 810. Friction forces between the first fastener 815 and the first portion 810 may secure the first portion 810 in its position relative to the second portion 820. For example, the first fastener 815 may be configured to prevent the first and second portions 810, 820 from being slidingly adjusted with respect to one another. When the first fastener 815 is loosened, the first portion 810 may be slidingly adjusted with respect to the second portion 820. The second fastener 825 may be configured to releasably secure the second portion 820 and the third portion 830 to one another. For example, the second fastener 825 may prevent movement of the second portion 820 with respect to the third portion 830. The second fastener 825 may be received by an aperture (not shown) in the third portion 830. When tightened, the second fastener 825 may be configured to abut the second portion 820. Friction forces between the second fastener 825 and the second portion 820 may secure the second portion 820 in its position relative to the third portion 830. For example, the second fastener 825 may be configured to prevent the second and third portions 820, 830 from being slidingly adjusted with respect to one another. When the second fastener 825 is loosened, the second portion 820 may be slidingly adjusted with respect to the third portion 830.

The measuring tool 800 may be adjustable to various lengths, for example, as shown in FIGS. 8B-8D. The various lengths may correspond to various widths of respective window treatments (e.g., roller tube assemblies of the respective window treatments). The measuring tool 800 may be adjusted between a first length L1 (e.g., as shown in FIG. 8B) and a second length L2 (e.g., as shown in FIG. 8C) by sliding the first portion 810 relative to the second portion 820 and/or the second portion 820 relative to the third portion 830. The measuring tool 800 may be adjusted to a third length L3 (e.g., as shown in FIG. 8D) by further sliding the first portion 810 relative to the second portion 820 and/or the second portion 820 relative to the third portion 830. The measuring tool 800 may be adjustable to match different window sizes, for example, such as to fit within casings of windows having different sizes. Although FIGS. 8B-8D show three example lengths for the measuring tool 800, it should be appreciated that the measuring tool 800 may be adjustable to a plurality of other lengths to accommodate a variety of window sizes. The measuring tool 800 may enable motorized window treatments having a roller tube assembly of one or more widths to be provided (e.g., to a consumer, a dealer, an installer, and/or the like) for installation. The measuring tool 800 may enable the installer to transfer an accurate measurement from a window (e.g., window casing) to a window treatment assembly such that it can be cut to the measured length. For example, the measuring tool 800 may eliminate measurement error(s) that may occur when a tape measure or similar measuring tool is used to measure the window and apply that measurement to the window treatment assembly.

FIG. 8B-8D depict the measuring tool 800 with first and second arms 845, 855 extending from respective bracket portions 840, 850. The arms 845, 855 may be configured to prevent mounting the motorized window treatment too deep (e.g., beyond a predetermined depth threshold) into the casing. When the motorized window treatment is mounted beyond the depth threshold, the batteries may not be able to be removed without removing the roller tube assembly from the brackets. The arms 845, 855 may be configured to pivot with respect to the respective bracket portions 840, 850. For example, the arms 845, 855 may be configured to pivot between a retracted position with respect to the respective bracket portions 840, 850 as shown in FIG. 8E and an extended position with respect to the respective bracket portions 840, 850 as shown in FIG. 8F. When in the retracted position, the arms 845, 855 may be substantially parallel to the outer wall 842, 852 of the respective bracket portion 840, 850. When in the extended position, the arms 845, 855 may be configured to be substantially perpendicular to the outer wall 842, 852 and/or substantially parallel to the upper wall 844, 854 of the respective bracket portion 840, 850. The arms 845, 855 may be configured to set the depth of the measuring tool 800 for marking the fastener locations of the brackets of the motorized window treatment. For example, the arms 845, 855 may be configured to limit the depth into the casing at which brackets of the motorized window treatment will be mounted. When the measuring tool 800 is inserted into opening with arms 845, 855 extended, the arms 845, 855 may prevent insertion of the measuring tool 800 any further than the arms 845, 855 abutting the casing 860. The depth may be limited such that the batteries of the motorized window treatment can be replaced when the roller tube assembly is rotated away from the window.

It should be appreciated that although the figures show the measuring tool 800 having the arms 845, 855, the arms 845, 855 are optional and the measuring tool 800 may not include the arms 845, 855 (e.g., when used to measure manually operated window treatments).

FIG. 8G depicts the measuring tool 800 inside an example casing 860. The casing 860 may surround a window (e.g., window casing) or a door (e.g., door casing). When the measuring tool 800 is inside the casing 860 (e.g., as shown in FIG. 8G), the outer walls 842, 852 may abut opposed sidewalls 862 of the casing 860.

The length of the measuring tool 800 may be adjusted such that the outer walls 842, 852 abut the respective sidewalls 862. The length of the measuring tool 800 may be set by the distance between the sidewalls 862 of the casing 860. For example, the measuring tool 800 may be less than the length when placed within the casing 860. The first portion 810, the second portion 820, and the third portion 830 may be adjusted such that the outer walls 842, 852 abut the sidewalls 862 of the window casing 860. The fasteners 815, 825 may be tightened when the outer walls 842, 852 abut the sidewalls 862 to secure the measuring tool 800 at length that corresponds to the distance between the sidewalls 862 of the casing 860 and/or secure the measuring tool 800 within the casing 860. For example, friction forces between the outer walls 842, 852 and the respective sidewalls 862 may secure the measuring tool 800 within the casing 860.

When the outer walls 842, 852 abut the respective sidewalls 862, the arms 845, 855 may be operated to the extended position to abut respective outer walls 865 of the casing 860. When in the extended position, the arms 845, 855 may also abut the upper surface 864 of the casing 860. The upper walls 844, 854 may be configured to set a height and the arms 845, 855 may be configured to set a depth of the brackets within the casing 860 such that the fasteners can be marked in the correct locations so that the batteries will be able to be accessed. The arms 845, 855 may prevent the window treatment from being installed too deep into the casing 860.

When the outer walls 842, 852 abut the respective sidewalls 862, a tool (e.g., such as the punch 470 shown in FIG. 6 and/or the punch 740 shown in FIG. 7B) may be used to mark the location of the holes 813, for example, such that brackets can be properly located and installed for the motorized window treatment. The measuring tool 800 may enable an installer to avoid measurement errors because the measuring tool is set at the proper measurement and can be transferred to a cutting location. For example, the measuring tool 800 may be configured to transfer a window measurement to a standard width roller tube assembly. That is, use of the measuring tool 800 avoids use of a tape measure (or similar tool) to measure the casing 860 and then applying that measurement to the window treatment assembly which introduces two instances of possible measurement error.

Although the measuring tool 800 is shown within the casing 860 in FIG. 8G, it should be appreciated that the measuring tool 800 may be alternatively located with respect to a window, door, or some other feature, such that an associated measurement can be used to cut the motorized window treatment to a size corresponding to the associated measurement.

FIG. 8H is a perspective view of the measuring tool 800 positioned on a roller tube assembly 880 that is installed on a window treatment cutting tool 890 (e.g., such as the window treatment cutting tool 700 shown in FIGS. 7A-7C). When the roller tube assembly 880 (e.g., such as the roller tube assembly of the window treatment assembly 111 shown in FIG. 1 and/or the roller tube assembly 780 shown in FIG. 7C) is positioned within the window treatment cutting tool 890, the measuring tool 800 may be positioned on the roller tube assembly 880, as shown in FIG. 8H. The measuring tool 800 may be positioned between a first end 882 of the roller tube assembly 880 and a cutting blade of the window treatment cutting tool 890 (e.g., such as the blade 734 shown in FIG. 7D). The measuring tool 800 may be set/locked to a measured length associated with a desired mounting location (e.g., such as the casing 860 shown in FIG. 8G) for the roller tube assembly 880. For example, the outer wall 842 may abut the first end 882 and the outer wall 852 may abut the cutting blade assembly such that the second end 884 of the roller tube assembly 880 extends beyond the blade (e.g., such as the blade 734). When the roller tube assembly 880 is positioned such that a first intermediate wall 843 abuts the first end 882 of the roller tube assembly 880 and a second intermediate wall 853 abuts the cutting blade, the measuring tool 800 may be removed and the roller tube assembly 880 may be locked into position, as described herein by rotating the clamping assembly (e.g., such as the clamping arm assembly 708 shown in FIG. 7C) onto the roller tube assembly 880. When the roller tube assembly 880 is locked into position, the blade may be engaged to the tube and the roller tube assembly 880 may be rotated (e.g., using a drill, a hand crank, etc.) to cut the roller tube assembly 880 to the desired size (e.g., that corresponds with the length of the measuring tool 800).

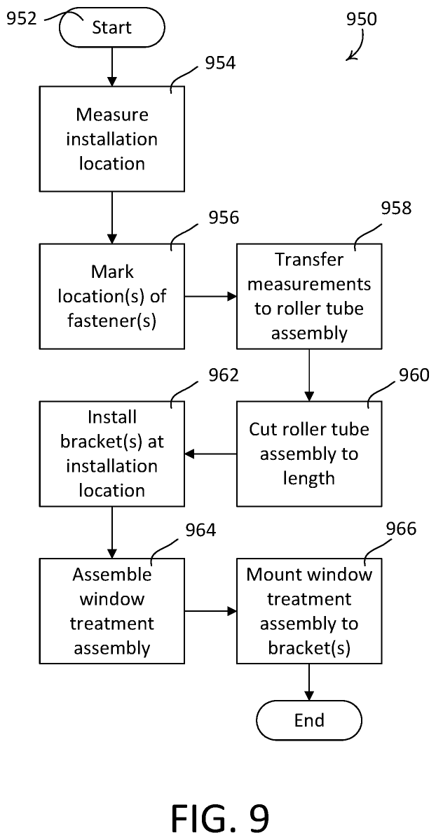

FIG. 9 is a flowchart of an example installation process 950 for a motorized window treatment (e.g., such as the motorized window treatment 100 shown in FIGS. 1-3). The motorized window treatment may be fabricated in one or more standard widths and may be adjusted (e.g. cut) based on actual installation location (e.g., mounting location) dimensions. The installation process 950 may be used to cut a standard width roller tube assembly (e.g., such as the roller tube assembly of the window treatment assembly 111 shown in FIG. 1) to a width that corresponds with the actual installation location dimensions. The installation process 950 may enable cutting a standard width roller tube assembly at a job site (e.g., at the installation location). The installation process 950 may start at 952, when an installer arrives at an installation location with the motorized window treatment.

At 954, the installer may measure the installation location. For example, the installer may make, at 954, one or more measurements at the installation location (e.g., proximate to a window). The installer may use a measuring tool (e.g., the measuring tool 400 shown in FIGS. 4-6, the measuring tools 720A, 720B shown in FIG. 7B, and/or the measuring tool 800 shown in FIGS. 8A-8H) to make the one or more measurements at the installation location. The one or more measurements may be associated with a window casing. For example, the measuring tool may be placed inside the window casing and adjusted such that portions of the measuring tool abut sidewalls of the window casing. The measuring tool may be adjusted by moving sliding portions such that outer faces of the spacers (e.g., such as the spacers 415, 425 shown in FIGS. 4-6) abut respective sidewalls of the window casing. The installer may lock the measuring tool at a length that corresponds to the distance (e.g., inside width) between the sidewalls of the window casing. For example, the sliding portions of the measuring tool may be secured with respect to one another at an overall length that corresponds to an inside width of the window casing (e.g., distance between the respective sidewalls of the window casing).

At 956, the measuring tool may be used to mark one or more locations of fastener holes. The fastener holes may mark the appropriate location for fasteners of brackets for mounting the motorized window treatment. One or more holes may be drilled at the one or more locations marked, at 956.

At 958, the one or more measurements at the installation location of the measuring tool may be transferred to a roller tube assembly of the motorized window treatment (e.g., the roller tube assembly of the window treatment assembly 111 shown in FIG. 1). For example, the measuring tool (e.g., locked at the length the corresponds to the distance between the sidewalls of the window casing) may be located proximate to a cutting blade of the window treatment cutting tool such that the roller tube assembly can be marked for cutting.

Additionally or alternatively, at 958, the roller tube assembly may be received by a window treatment cutting tool (e.g., the window treatment cutting tool 700 shown in FIGS. 7A-7C). While the roller tube assembly is received by the window treatment cutting tool, the measuring tool (e.g., locked at the length the corresponds to the distance between the sidewalls of the window casing) may be used to transfer the measured length to the roller tube assembly. The roller tube assembly may be secured within the window treatment cutting tool. For example, a clamping assembly of the window treatment cutting tool may be configured to be operated to removably secure the roller tube assembly within the window treatment cutting tool. The clamping assembly may be pivoted such that the clamping roller tube applies a force on the roller tube assembly to secure the roller tube assembly within the window treatment cutting tool.

At 960, the roller tube assembly may be cut to a width, for example, that corresponds with the distance between the sidewalls of the window casing. The roller tube assembly may be cut, at 960, using a cutting blade of the window treatment cutting tool. For example, the cutting blade may cut a fabric of the roller tube assembly (e.g., such as the flexible material 120 shown in FIGS. 1 and 2) and/or a roller tube of the roller tube assembly (e.g., such as the roller tube 110 shown in FIG. 1). The cutting blade may be a razor blade or utility knife blade (e.g., as shown in FIGS. 7A and 7C), and/or the like. In an example using the window treatment cutting tool 700 shown in FIGS. 7A-7C, the roller tube assembly may be rotated by driving cylindrical support tubes (e.g., such as cylindrical support tubes 702A, 702B shown in FIGS. 7A, 7C, and 7D) such that successive layers of the fabric and the roller tube are cut by the cutting blade. For example, the roller tube assembly may be cut by rotating one or more cylindrical support tubes as the cutting blade cuts successive layers of fabric of the roller tube assembly. The installer may apply a force to a blade support member (e.g., such as the blade support member 732 shown in FIGS. 7A, 7C, 7F, 7G, and 7H) to cut successive layers of the fabric, for example, until the roller tube assembly is cut into two pieces.

At 962, one or more mounting brackets (e.g., such as brackets 130A, 130B shown in FIGS. 1-3) may be installed at the installation location. For example, the one or more brackets may be aligned with one or more fastener marks such that fasteners may be installed through the bracket(s) at the one or more fastener marks.

At 964, a window treatment assembly that includes the roller tube assembly may be assembled. For example, to assemble the window treatment assembly at 964, a motor drive unit may be installed in a first end of the roller tube of the roller tube assembly (e.g., the first end 112 of the roller tube 110) and an idler end portion (e.g., the idler end portion 114 of the motorized window treatment 100) may be installed in a second end of the roller tube of the roller tube assembly (e.g., the second end 113 of the roller tube 110).

At 966, the window treatment assembly may be mounted to the one or more brackets. For example, to mount the window treatment assembly to the one or more brackets at 966, the motor drive unit may be connected to a first one of the brackets and the idler end portion may be connected to a second one of the brackets. The installation process 950 may end when the window treatment assembly is mounted to the one or more brackets.

Although the installation process 950 is shown having the steps shown in FIG. 9, it should be appreciated that the installation process 950 is not limited to these steps. Rather, the installation process 950 may include one or more of the processes described herein and/or one or more other processes. Although the installation process 950 is described and shown in FIG. 9 as having an order, it should be appreciated that the steps in the installation process 950 may be performed in other orders.

What is claimed is:

1. A window treatment cutting tool comprising:
a pair of cylindrical support tubes configured to support a roller tube assembly having a longitudinal axis, wherein the pair of cylindrical support tubes are parallel to one another;
a clamping assembly configured to abut the roller tube assembly to secure the roller tube assembly against the pair of cylindrical support tubes;
a cutting arm assembly comprising a blade support member and a blade attached to the blade support member, the blade support member configured to be biased toward the cylindrical support such that the blade contacts a flexible material of the roller tube assembly; and
an adapter that is operatively coupled to one or more of the pair of cylindrical support tubes, the adapter configured to transfer rotation to the one or more of the pair of cylindrical support tubes.

2. The window treatment cutting tool of claim 1, wherein the clamping assembly comprises a clamping tube that is positioned off-center from the top of the roller tube assembly when the clamping assembly abuts the roller tube assembly.

3. The window treatment cutting tool of claim 2, wherein the clamping tube is configured to contact the roller tube assembly at a first contact location that is offset from a vertical plane defined by the roller tube assembly, wherein the vertical plane extends through the longitudinal axis of the roller tube assembly.

4. The window treatment cutting tool of claim 3, wherein the first contact location is angularly offset from the vertical plane by between 5 and 30 degrees.

5. The window treatment cutting tool of claim 2, wherein a rotation axis of the clamping tube is offset from the longitudinal axis of the roller tube assembly by a contact angle.

6. The window treatment cutting tool of claim 5, wherein the contact angle is between 5 and 30 degrees.

7. The window treatment cutting tool of claim 1, wherein the blade is configured to contact the roller tube assembly at a second contact location that is offset from a vertical plane defined by the roller tube assembly by an offset angle in a plane that is defined by a transverse direction that is perpendicular to the longitudinal axis of the roller tube and a radial direction R that is perpendicular to the longitudinal axis of the roller tube, wherein the vertical plane extends through the longitudinal axis of the roller tube assembly.

8. The window treatment cutting tool of claim 7, wherein the offset angle of the second contact location is between 45 and 65 degrees.

9. The window treatment cutting tool of claim 7, wherein the blade is oriented at an offset from a tangent defined by the roller tube assembly at the second contact location of the blade.

10. The window treatment cutting tool of claim 9, wherein the offset that the blade is oriented is between 10 and 30 degrees from the tangent at the second contact location.

11. The window treatment cutting tool of claim 1, further comprising a gear assembly that is operatively coupled to the adapter.

12. The window treatment cutting tool of claim 11, wherein the gear assembly comprises a drive gear and a pair of driven gears.

13. The window treatment cutting tool of claim 12, wherein each of the pair of driven gears is operatively coupled to a respective one of the pair of cylindrical support tubes such that rotation of the drive gear is transferred to the pair of cylindrical support tubes via the pair of driven gears.

14. The window treatment cutting tool of claim 13, wherein the pair of cylindrical support tubes comprises respective portions with teeth.

15. The window treatment cutting tool of claim 14, wherein the teeth of the pair of driven gears is configured to engage with teeth of respective ones of the pair of cylindrical support tubes.

16. The window treatment cutting tool of claim 1, further comprising a pair of guide walls located at opposed ends of the pair of cylindrical support tubes, each of the pair of guide walls defining a notch that is configured to receive the roller tube assembly.

17-46. (canceled)
